(19) United States
(12) Patent Application Publication
(10) Pub. No.: US 2026/0121837 A1
(43) Pub. Date: Apr. 30, 2026

(54) DATA ENCRYPTION AND DECRYPTION USING SKIP BITS AND VARIABLE XOR QUANTITY

(71) Applicant: CERULEANT SYSTEMS, LLC, Plymouth, MN (US)

(72) Inventors: Jason McNUTT, Plymouth, MN (US); Amy J. WITTY, Plymouth, MN (US); Scott HANSON, North Oaks, MN (US)

(21) Appl. No.: 19/420,257

(22) Filed: Dec. 15, 2025

Related U.S. Application Data
(63) Continuation-in-part of application No. 18/075,792, filed on Dec. 6, 2022, now Pat. No. 12,574,208.
(63) Continuation-in-part of application No. 18/904,591, filed on Oct. 2, 2024.
Application No. 18/904,591 is a continuation-in-part of application No. 18/075,792, filed on Dec. 6, 2022, now Pat. No. 12,574,208.

(51) Int. Cl. H04L 9/06

(52) U.S. Cl. CPC H04L 9/065

(57) ABSTRACT

A data encryption method using linear-feedback shift registers (LFSRs) is disclosed. The method includes identifying one or more objects each of which comprises a sequence of object bits, and using each object to generate a plurality of logic blocks by: creating an LFSR seed comprising at least a portion of the object bits of the object, wherein the LFSR seed provides an initial state of an LFSR; implementing the LF SR to generate a plurality of LFSR outputs; and using the LFSR outputs to generate the logic blocks. The method also includes encrypting a plurality of data blocks in accordance with an encryption scheme that applies a screen and the LFSR-generated logic blocks. The encrypted data blocks may then be decrypted in accordance with a decryption scheme that applies an inverse screen and the same LFSR-generated logic blocks that were used in the encryption scheme.

### CROSS-REFERENCE TO RELATED APPLICATIONS

This application is a continuation-in-part of and claims priority to U.S. patent application Ser. No. 18/075,792 filed on Dec. 6, 2022 and U.S. patent application Ser. No. 18/904,591 filed on Oct. 2, 2024, which is a continuation-in-part of and claims priority to U.S. patent application Ser. No. 18/075,792 filed on Dec. 6, 2022, the entire disclosures of which are incorporated herein by reference.

### BACKGROUND OF THE INVENTION

### 1. Field of the Invention

The present invention relates generally to data security and, more specifically, to methods and systems for encrypting data for secure storage or transport while allowing the encrypted data to remain accessible to the appropriate users and systems.

### 2. Description of Related Art

The sheer volume and accessibility of data have risen rapidly in recent years. Organizations and individual users increasingly look to electronic data as a primary source of information-rather than tangible documents such as paper-because of the persistence, availability, searchability, and accessibility of electronic data. Also, robust networking and communications technologies have made data accessible to user devices in a variety of contexts, including when a user device establishes a remote connection to a primary network that hosts the accessed data. Further, business and legal requirements have demanded the retention and general availability of historic data.

While vast quantities of data are constantly created and persisted, organizations and individual users must have the ability to access the data. The provision of data access does cause a significant actual and perceived risk from data breaches caused by unauthorized users. While access control methods exist to mitigate improper access, the wide variety of methods of data access make it nearly impossible to prevent at least some unauthorized users from accessing data that they should not be able to access. For example, data is routinely saved on network storage, on local devices, on remote storage devices outside a network, and on removable storage devices such as universal serial bus (USB) drives. Because data is often resident in multiple locations with varying degrees of security, there is a persistent risk of improper data access. There are generally no available techniques for ensuring that data stored on disparate media will be secured using a repeated framework. Further, organizations and individual users face business and legal requirements to ensure that their data is secured in the face of these risks.

Conventional methods have attempted to address these problems through the issuance of secret keys that are used to encrypt and decrypt data blocks. For example, the Advanced Encryption Standard (AES) established by the U.S. National Institute of Standards and Technology provides an encryption scheme that uses a fixed block size of 128 bits and a key size of 128, 192, or 256 bits. The key size specifies the number of transformation rounds required to encrypt each data block to provide an acceptable level of data security. Specifically, AES uses 10 transformation rounds for 128-bit keys, 12 transformation rounds for 192-bit keys, and 14 transformation rounds for 256-bit keys. Each transformation round consists of several processing steps, including byte substitution, shifting rows, mixing columns, and round key addition. A set of reverse transformation rounds are applied to decrypt each encrypted data block using the same key.

While conventional methods have provided adequate data security, they lack the ability to provide robust encryption in an efficient manner. For example, the multiple transformation rounds used in AES increase the computational complexity required for the encryption and decryption of data. Also, the encryption and decryption schemes of AES do not provide flexibility to support scalable solutions. Thus, there remains a need in the art for an improved encryption and decryption method that overcomes some or all of the drawbacks associated with existing methods and/or that offers other advantages compared to existing methods.

### BRIEF SUMMARY OF THE INVENTION

The present invention is directed to methods and systems for encrypting and decrypting data using screens and inverse screens, respectively, in combination with logic blocks generated with linear-feedback shift registers (LFSRs). Various examples of encryption and decryption schemes are provided. Each encryption scheme includes a series of transformations that convert a data block into an encrypted data block by (a) applying at least one screen in accordance with a bit remapping operation and (b) applying one or more LFSR-generated logic blocks in accordance with a bit modification operation. Each decryption scheme includes a series of transformations that convert a previously-encrypted data block into the original data block by (a) applying at least one inverse screen in accordance with an inverse bit remapping operation and (b) applying the one or more LFSR-generated logic blocks in accordance with the bit modification operation. Preferably, the encryption and decryption schemes each utilize a single round of transformation steps to provide a high level of data security while allowing access to the data by authorized users and systems.

In some embodiments, the one or more LFSR-generated logic blocks used in the encryption and decryption schemes are generated from one or more LFSR objects—wherein the number of LFSR objects equals the number of logic blocks generated for each data block. Each LFSR object comprises a sequence of object bits that is used to generate a different logic block for each data block. The logic blocks are generated by (a) creating an LFSR seed comprising at least a portion of the object bits of the LFSR object, wherein the LFSR seed provides an initial state of an LFSR, (b) identifying at least one skip bit index, (c) implementing the LFSR to generate a plurality of LFSR outputs, and (d) extracting the skip bits from the LFSR outputs to generate the logic blocks.

The present invention improves the functionality of computer devices by providing increased data security while minimizing the computational complexity of the encryption and decryption schemes. Also, the invention provides an improvement in computer technology by storing or transporting data within data blocks that have been encrypted using a unique encryption scheme while enabling access to the data via a corresponding decryption scheme.

Various embodiments of the present invention are described in detail below, or will be apparent to one skilled in the art based on the disclosure provided herein, or may be learned from the practice of the invention. It should be understood that the above brief summary of the invention is not intended to identify key features or essential components of the embodiments of the present invention, nor is it intended to be used as an aid in determining the scope of the claimed subject matter as set forth below.

### BRIEF DESCRIPTION OF THE DRAWINGS

Various exemplary embodiments of the present invention are described in detail below with reference to the attached drawing figures, wherein:

FIG. 1 depicts an index block with both cell references and index coordinates;

FIG. 2 depicts the components used in a sub-screen generation process, including the components of an initialization vector (a Binary IV setup object and an IV offset vector) and three setup objects (a binary setup object 0, an integer setup object 1, and a binary setup object 2);

FIG. 3 depicts a process for generating a binary object based on the Binary IV setup object and the binary setup object 0 of FIG. 2;

FIG. 4 depicts a process for generating a mask based on the Binary IV setup object and the binary setup object 2 of FIG. 2;

FIG. 5 depicts a process for generating a movement instructions table based on the binary object of FIG. 3 and the integer setup object 1 of FIG. 2;

FIG. 6 depicts exemplary movement instructions that are generated using the process of FIG. 5;

FIG. 7 depicts a process for generating sub-screen remapping relationships;

FIG. 8 depicts an index block and sub-screens with remapping relationships generated using the process of FIG. 7;

FIG. 9 depicts the sub-screen remapping relationships of FIG. 8 provided in a table format;

FIGS. 10A-10E depict exemplary LFSRs;

FIG. 11 depicts an exemplary logic block generation process to create two or more logic blocks for each LFSR seed;

FIG. 12 depicts an exemplary encryption scheme of a cipher;

FIGS. 13A-13B depict an exemplary table for determining the front XOR block and the back XOR block to apply;

FIG. 14 depicts an exemplary decryption scheme of an inverse cipher;

FIG. 15 depicts a bit stream and byte stream notation.

FIGS. 16A-16B depict a bytestream setup object, a key parsing table, and associated bytestream screen objects;

FIG. 17 depicts LFSRs A, B, C, and D with their associated seed, length, and tap bit positions.

FIG. 18 depicts the output of LFSR A of FIG. 17, a skip bit, and the resulting XOR Block A.

FIG. 19 depicts the output of LFSR B of FIG. 17, a skip bit, and the resulting XOR Block B.

FIG. 20 depicts the output of LFSR C of FIG. 17, a skip bit, and the resulting XOR Block C.

FIG. 21 depicts the output of LFSR D of FIG. 17, a skip bit, and the resulting XOR Block D.

FIG. 22 depicts a front XOR block and back XOR block determined based on the skip bits extracted from the LFSR output.

FIG. 23 depicts a process of identifying a skip bit for XOR Blocks A, B, C, and D.

FIG. 24 is a block diagram of an exemplary computing device that enables the encryption and decryption of data;

FIG. 25 is a block diagram of an exemplary system that enables the transport of encrypted data between first and second computing devices;

FIG. 26 is a flowchart of an exemplary data encryption method performed by the computing device of FIG. 24 or one of the computing devices of FIG. 25; and

FIG. 27 is a flowchart of an exemplary data decryption method performed by the computing device of FIG. 24 or one of the computing devices of FIG. 25.

### DETAILED DESCRIPTION OF EXEMPLARY EMBODIMENTS

The present invention is directed to methods and systems for encrypting and decrypting data using screens and inverse screens, respectively, in combination with logic blocks generated with linear-feedback shift registers (LFSRs). While the invention will be described in detail below with reference to various exemplary embodiments, it should be understood that the invention is not limited to the specific configurations or methodologies of these embodiments. In addition, although the exemplary embodiments are described as embodying several different inventive features, one skilled in the art will appreciate that any one of these features could be implemented without the others in accordance with the present invention.

In the present disclosure, references to “one embodiment,” “an embodiment,” “an exemplary embodiment,” or “embodiments” mean that the feature or features being described are included in at least one embodiment of the invention. Separate references to “one embodiment,” “an embodiment,” “an exemplary embodiment,” or “embodiments” in this disclosure do not necessarily refer to the same embodiment and are also not mutually exclusive unless so stated and/or except as will be readily apparent to one skilled in the art from the description. For example, a feature, structure, function, etc. described in one embodiment may also be included in other embodiments, but is not necessarily included. Thus, the present invention can include a variety of combinations and/or integrations of the embodiments described herein.

The disclosure provided below uses various terms to describe the encryption and decryption schemes of the present invention. The meaning of these terms should be understood from the context of the disclosure as further defined in Table 1 below:

TABLE 1

| Term | Definition |
|---|---|
| Binary Object | An object consisting of a tuple of |
| | random bits. |
| Bit | A binary digit having a value of 0 or 1. |
| Bit Modification | A logical operation in which first and |
| Operation | second input bits determine an output |
| | bit. The logical operation is its own |
| | inverse to enable use in both a cipher |
| | and inverse cipher. Examples of such a |
| | logical operation include an XOR logical |
| | operation and an XNOR logical operation. |
| Bit Remapping | Transformation used in a cipher that |
| Operation | remaps each bit from its current index |
| | position to a destination index position. |
| Block | A block-sized tuple of bits positioned |
| | within an index block. |
| Block Size | Length or size of a block (in bits), |
| | denoted as “B.” |
| Cipher | A series of transformations that converts |
| | plaintext to ciphertext in accordance with |
| | an encryption scheme that applies at least |
| | one screen and at least one logic block to |
| | each data block. |
| Ciphertext | Data output from a cipher or input to |
| | an inverse cipher. |
| Data Block | A block containing a segment of plaintext. |
| Index Block | A block-sized tuple of index positions. |
| Index Position | An integer representing the position of |
| | a specific bit within an index block, |
| | denoted as “i.” |
| Initialization | Initialization data used to generate a |
| Vector | screen, inverse screen, and/or logic |
| | blocks, denoted as “IV.” |
| Integer Object | An object consisting of a tuple of random |
| | non-negative decimal integers. |
| Inverse Bit | Transformation used in an inverse cipher |
| Remapping | that is the inverse of a bit remapping |
| Operation | operation. |
| Inverse Cipher | A series of transformations that converts |
| | ciphertext to plaintext in accordance with |
| | a decryption scheme that applies at least |
| | one inverse screen and at least one logic |
| | block to each encrypted data block. |
| Inverse Screen | A block-sized tuple of rearranged index |
| | positions for use in performing an inverse |
| | bit remapping operation. |
| LFSR Object | A binary object used to generate logic |
| | blocks, denoted as “LO.” |
| Linear-Feedback | A shift register in which an output bit |
| Shift Register | is a linear function of its previous state, |
| | denoted as “LFSR.” |
| Logic Block | A block containing a plurality of bits for |
| | use in performing a bit modification operation. |
| | Examples of such a block include an XOR block |
| | and an XNOR block. |
| Mask | A block containing a plurality of mask bits |
| | for use in generating a screen and inverse |
| | screen. |
| Movement | A set of instructions describing where to |
| Instructions | move each index position within an index |
| | block for use in generating a screen and |
| | inverse screen. |
| Object | A secret, cryptographic tuple of data that |
| | may be used by a cipher or inverse cipher. |
| Object Length or | For a binary object, the length or size of |
| Object Size | the object in bits. For an integer object, |
| | the number of integer elements that comprise |
| | the object. |
| Offset Vector | An xy-coordinate that shifts each movement |
| | instruction by a fixed amount for use in |
| | generating a screen and inverse screen. |
| Plaintext | Data input to a cipher or output from an |
| | inverse cipher. |
| Screen | A block-sized tuple of rearranged index |
| | positions for use in performing a bit |
| | remapping operation. |
| Setup Object | A binary object or integer object used to |
| | generate a screen or inverse screen, denoted |
| | as “SO.” |
| Signal Bit | A bit used to determine whether its associated |
| | XOR block will be applied to the next data |
| | block |
| Skip Bit | A bit extracted from an LFSR's output bits which |
| | may optionally be used as a signal bit. |
| Sub-Block | A sub-block-sized subset of a block. |
| Sub-Block Size | Length or size of a sub-block (in bits), |
| | denoted as “R.”. The sub-block size |
| | R is a factor of the block size B, such that |
| | R = B/x for some positive integer x. |
| Sub-Screen | A sub-block-sized subset of a screen. |
| | Multiple sub-screens are combined to |
| | create a screen. |
| Variable | An operation comparing signal bits associated |
| XOR | with two logic blocks to determine whether to |
| Operation | apply one or both of the logic blocks in a bit |
| | modification operation. |
| Tuple | A collection of elements that is ordered |
| | (i.e., a sequence) and may have duplicate |
| | elements. |
| XNOR Block | A logic block for use in performing an |
| | XNOR logical operation. |
| XNOR Logical | Exclusive-NOR operation. |
| Operation | |
| XOR Block | A logic block for use in performing an XOR |
| | logical operation. |
| XOR Logical | Exclusive-OR operation. |
| Operation | |

As described below, the present invention is implemented on a computing device configured to identify data to be encrypted (i.e., the plaintext). For example, data may be identified for encryption if the data is being stored locally or remotely in a context that requires encryption or transported in a context that requires encryption. The context that requires encryption may be based, for example, on a policy associated with one or more of the computing device, a user, an organization, a network, a software application, or any other attributes.

The computing device is configured to divide the identified data into multiple data segments based upon a selected block size (B). It can be appreciated that the number of data segments is dependent on the size of the identified data and the selected block size. For example, if the computing device identifies a file of 1 megabyte for encryption and the selected block size is 128 bits, the computing device will divide the file into 62,500 data segments. Exemplary block sizes are 32 bits, 64 bits, 128 bits, 256 bits, 512 bits, 1,024 bits, 2,048 bits, 4,096 bits, 8,192 bits, 16,384 bits, 32,768 bits, 65,536 bits or greater. Of course, other block sizes may be used within the scope of the present invention.

The computing device is also configured to position the bits of each data segment within an index block to create a data block. The index block is a virtual structure that identifies a plurality of index positions arranged in a predetermined manner. The virtual structure may comprise a one-dimensional array (i.e., a linear array of data), a two-dimensional array (i.e., data arranged in rows and columns), a three-dimensional array (i.e., an array of two-dimensional arrays), or any other type of data structure known in the art. Each index position may contain a single bit or a plurality of bits (e.g., eight bits) of the data segment.

The computing device is also configured to implement a cipher comprising a series of transformations that converts plaintext to ciphertext. The cipher utilizes an encryption scheme that applies at least one screen and at least one LFSR-generated logic block to each data block. The screen is applied in connection with a bit remapping operation that remaps the bits in each data block, and the LFSR-generated logic block is applied in connection with a bit modification operation that modifies certain bits in each data block. Preferably, the cipher applies the transformations in a single transformation round.

The computing device is further configured to implement an inverse cipher comprising a series of transformations that converts ciphertext to plaintext. The inverse cipher utilizes a decryption scheme that applies at least one inverse screen and at least one LFSR-generated logic block to each previously-encrypted data block. The inverse screen is applied in connection with an inverse bit remapping operation that remaps the bits in each encrypted data block, and the LFSR-generated logic block is applied in connection with a bit modification operation that modifies certain bits in each encrypted data block. Preferably, the inverse cipher applies the transformations in a single transformation round.

Examples of different encryption and decryption schemes that may be implemented in accordance with the present invention are provided in Table 2 below:

TABLE 2

| Encryption Scheme | Decryption Scheme |
|---|---|
| Step 1: Apply Logic Block | Step 1: Apply Inverse Screen |
| Step 2: Apply Screen | Step 2: Apply Logic Block |
| Step 1: Apply Screen | Step 1: Apply Logic Block |
| Step 2: Apply Logic Block | Step 2: Apply Inverse Screen |
| Step 1: Apply Logic Block | Step 1: Apply Inverse Screen |
| Group | |
| Step 2: Apply Screen | Step 2: Apply Logic Block |
| | Group |
| Step 1: Apply Screen | Step 1: Apply Logic Block |
| | Group |
| Step 2: Apply Logic Block | Step 2: Apply Inverse Screen |
| Group | |
| Step 1: Apply Logic Block A | Step 1: Apply Logic Block B |
| Step 2: Apply Screen | Step 2: Apply Inverse Screen |
| Step 3: Apply Logic Block B | Step 3: Apply Logic Block A |
| Step 1: Apply Logic Block | Step 1: Apply Logic Block |
| Group A | Group B |
| Step 2: Apply Screen | Step 2: Apply Inverse Screen |
| Step 3: Apply Logic Block | Step 3: Apply Logic Block |
| Group B | Group A |

With reference to Table 2, it can be seen that the same LFSR-generated logic block(s) are used in both the encryption and decryption schemes i.e., the bit modification operation performed by each logic block is its own inverse. It can also be seen that the LFSR-generated logic block(s) may be applied before and/or after the screen/inverse screen, as shown, and may comprise a single logic block or a logic block group (i.e., two or more logic blocks). The encryption and decryption schemes shown in Table 2 apply a single screen and a single inverse screen, respectively; however, multiple screens and inverse screens may be applied in other schemes. Of course, other encryption and decryption schemes that apply at least one screen/inverse screen and at least one LFSR-generated logic block—and optionally other types of transformations (including, but not limited to, one or more stumbling blocks as described in U.S. Pat. No. 10,902,142)—will be apparent to one skilled in the art.

The same screen/inverse screen and logic block(s) may be applied to all of the data blocks during an encryption/decryption session, or, the screen/inverse screen and/or logic block(s) may be unique to each data block that is processed during the encryption/decryption session.

In a preferred embodiment, the encryption scheme encrypts each of the data blocks by applying one or more logic blocks, then applying a screen, and then applying one or more logic blocks. Conversely, the decryption scheme decrypts each of the previously-encrypted data blocks by applying one or more logic blocks, then applying an inverse screen, and then applying one or more logic blocks. The logic blocks applied before the screen during the encryption process are the same logic blocks applied after the inverse screen during the decryption process and, similarly, the logic blocks applied after the screen during the encryption process are the same logic blocks applied before the inverse screen during the decryption process. In this embodiment, the same screen is used to encrypt all of the data blocks during an encryption session and, similarly, the same inverse screen is used to decrypt all of the encrypted data blocks during a decryption session. However, the logic blocks are unique to each data block during the encryption/decryption session.

The length of an encryption/decryption session may comprise any period of time determined by a particular implementation. For example, an encryption/decryption session may begin when a user opens a software application and end when the user closes the software application. As another example, an encryption/decryption session may comprise a defined period of time. As yet another example, an encryption/decryption session may be determined by the amount of data processed by a computing device—e.g., a session may end when the amount of processed data reaches a predetermined number of bytes. Of course, other ways to determine the length of an encryption/decryption session will be apparent to one skilled in the art.

As described in greater detail below, the screen and inverse screen are generated based on movement instructions created from a binary object and an integer object. In a preferred embodiment, the binary object and integer object are derived from a combination of public and private data such as an initialization vector and setup objects. The screen and inverse screen may also be generated based on a mask created from one or more binary objects. In a preferred embodiment, the mask is created from a combination of public and private setup objects. The screen and inverse screen may also be generated based on an offset vector.

As described in greater detail below, each logic block is generated based on one or more binary objects. In a preferred embodiment, each logic block is created from an LFSR object using a linear-feedback shift register, wherein each LFSR object is used to create a unique logic block for each data block to be processed. Thus, the number of LFSR objects equals the number of logic blocks generated for each data block during the encryption/decryption session (although additional LFSR objects may be provided that are not used to generate logic blocks, as described below).

One type of logic block is an XOR block. Specifically, an XOR block may be used to perform an XOR logical operation in which the output is true only when the inputs are different, as shown in Table 3 below:

TABLE 3

| Input 1 | Input 2 | Output |
|---|---|---|
| 0 | 0 | 0 |
| 1 | 1 | 0 |
| 0 | 1 | 1 |
| 1 | 0 | 1 |

Another type of logic block is an XNOR block. Specifically, an XNOR block may be used to perform an XNOR logical operation in which the output is true only when the inputs are the same, as shown in Table 4 below:

TABLE 4

| Input 1 | Input 2 | Output |
|---|---|---|
| 0 | 0 | 1 |
| 1 | 1 | 1 |
| 0 | 1 | 0 |
| 1 | 0 | 0 |

Thus, it can be appreciated that an XNOR block is equivalent to an XOR block in the context of the present invention—i.e., an XNOR logical operation is simply an XOR logical operation in which the output is inverted. Notably, an XOR block and an XNOR block are their own inverse and can be used in both the cipher and inverse cipher as described herein.

Provided in Section I below is a detailed description of exemplary encryption and decryption schemes that may be used in accordance with the present invention. Also provided in Section II below is a detailed description of exemplary computing devices and methods that may be used to encrypt and decrypt data blocks for secure storage or transport of data in accordance with the present invention.

### I. EXEMPLARY ENCRYPTION AND DECRYPTION SCHEMES

### A. Index Block

In an exemplary embodiment, the index block comprises a plurality of index positions representing the position of a specific bit within an index block arranged as a two-dimensional array—i.e., the index positions consist of consecutive integers from 0 to B−1, starting in the top-left corner and increasing from left to right and then row-wise in carriage-return fashion, with B−1 in the bottom-right corner. Thus, this embodiment utilizes a 0-based numbering scheme (although a 1-based numbering scheme could alternatively be used).

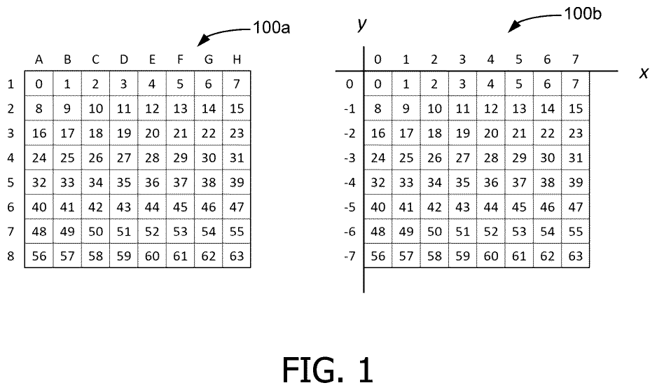

FIG. 1 shows an example of an index block 100a formatted as a square and having 8 rows (rows 1-8) and 8 columns (columns A-H) to provide 64 index positions, as shown, wherein each index position may be referenced by its column and row position within index block 100a. FIG. 1 shows an example of an alternative index block 100b that is situated in Quadrant IV of the rectangular coordinate plane, wherein each index position may be referenced by its xy-coordinate within index block 100b. In both cases, the index positions consist of consecutive integers from 0 to 63 starting in the top-left corner and increasing from left to right and then row-wise in carriage-return fashion with 63 in the bottom-right corner. While a 0-based numbering scheme is used in this example, a 1-based numbering scheme could alternatively be used. One skilled in the art will appreciate that index blocks 100a and 100b may be used to create a data block containing 64 bits (if a single bit is placed in each index position) or a data block containing 512 bits (if eight bits are placed in each index position). Of course, other block sizes may be used in accordance with the present invention.

### B. Object Sets

In this embodiment, the encryption and decryption schemes use two object sets-a setup object set and an LFSR object set. The setup object set includes a binary setup object 0 (SO_0), an integer setup object 1 (SO_1), and optionally a binary setup object 2 (SO_2). The LFSR object set includes a plurality of LFSR objects (LO_0, LO_1, etc.). Each object consists of a sequence of cryptographically random bits or integers.

The binary setup object 0 (SO_0) is used to generate movement instructions in connection with the sub-screen generation process. In this embodiment, the binary setup object 0 (SO_0) comprises a sequence of bits having a length of 2B.

The integer setup object 1 (SO_1) is also used to generate movement instructions in connection with the sub-screen generation process. In this embodiment, the integer setup object 1 (SO_1) comprises a sequence of positive integers having a length of 2B, wherein the integers preferably cover the entire range of possible integer values with equal probability. For a sub-block having a size R with m rows and n columns, the integer setup object 1 (SO_1) may be expressed as follows:

$$For odd i \text{:} 0 \leq SO\_ {1}_{i} < n$$

$$For even i \text{:} 0 \leq SO\_ {1}_{i} < m$$

The binary setup object 2 (SO_2) is optionally used to generate a mask in connection with the sub-screen generation process. In this embodiment, the binary setup object 2 (SO_2) comprises a sequence of bits having a length of B.

It should be understood that the setup objects may be larger than the lengths specified above, especially when it is desirable to maintain flexibility to enable the utilization of multiple different block sizes. In that case, only the first B or 2B elements—bits or integers—in the sequence will be considered to be SO_n for use in connection with the sub-screen generation process.

The LFSR objects (LO_0, LO_1, etc.) are used to create logic blocks in connection with the logic block generation process. In this embodiment, each LFSR object has the same size and comprises a sequence of bits having a length that is greater than the maximum LFSR seed length (k) identified in the LFSR object parameters contained in the initialization vector or configuration settings, as described below. Each LFSR object is used to create a plurality of logic blocks-one for each of the data blocks. Thus, the number of LFSR objects equals the number of logic blocks created for each of the data blocks in accordance with the encryption/decryption schemes. Of course, in other embodiments, the LFSR object set could include a larger number of LFSR objects, some of which will not be used to create logic blocks. For example, if there are eight LFSR objects but the encryption/decryption scheme only requires the creation of four logic blocks for each of the data blocks, then only four of the eight LFSR objects will be used.

In some embodiments, the object sets are assigned by an organization, software manufacturer, or other third party. For example, the Information Technology (IT) department of an organization could assign the object sets to each employee when issuing a computing device for use at the organization. As another example, a software manufacturer could provide the object sets associated with the operating system (OS) installed on a computing device, wherein the computing device may not be used without those object sets. Thus, the objects in the object sets are private objects that may be used across different encryption/decryption sessions. It should be understood that the object sets could be stored on the computing device or on a storage device separate from the computing device.

### C. Initialization Vector (IV)

In this embodiment, the encryption and decryption schemes use an initialization vector that includes three components: (1) a binary IV setup object (BIVSO), (2) an IV offset vector, and (3) LFSR object parameters. These components are provided by a trusted authority (i.e., public data) for use during a single encryption/decryption session. In some embodiments, the initialization vector is manipulated such that an attacker would not be able to parse the components (e.g., the complexity of the initialization vector or the amount of interaction with the initialization vector could be greater to increase unknown variables).

The binary IV setup object is used in connection with the sub-screen generation process. In this embodiment, the binary IV setup object comprises a sequence of bits having a length of 2B.

The IV offset vector is also used in connection with the sub-screen generation process. In this embodiment, the IV offset vector comprises two integers (p,q). For a sub-block having a size R with m rows and n columns, the two integers (p,q) of the IV offset vector may be expressed as follows:

$$p ∈ ℤ \text{:} 0 \leq p < n$$

$$q ∈ ℤ \text{:} - m < q \leq 0$$

The LFSR object parameters are used in connection with the logic block generation process. In this embodiment, the LFSR object parameters specify seven types of information for each logic block:
1. LFSR Object: The specific LFSR object (LO_n) from which the bits shall be retrieved to populate the seed used to generate the logic block. As described below, the seed is the initial value of the LFSR.
2. Position: The position of the logic block within the cipher. Logic blocks placed before the screen are said to be at the “front” of the cipher, while logic blocks placed after the screen are said to be at the “back” of the cipher. Preferably, the number of logic blocks is an even number such that half of the logic blocks may be positioned at the front of the cipher and the other half of the logic blocks may be positioned at the back of the cipher. The configuration settings may specify the approach for determining the position of each logic block. For example, the number of the LFSR object (LO_n) may determine the position of each logic block (e.g., even-numbered XOR blocks may be positioned at the front of the cipher and odd-numbered logic blocks may be positioned at the back of the cipher). Other approaches for determining the position of each XOR block will be apparent to one skilled in the art.
3. LFSR Direction: A logic block generated from an LFSR will be referred to as either a “forward” logic block or a “reverse” logic block, as described below. In embodiments where multiple logic blocks are used on each side of the screen, the logic blocks may be generated by operation of their corresponding LFSRs in the same direction or in opposing directions. For example, if there are two logic blocks (“A” and “B”) at the front of the cipher and two logic blocks (“C” and “D”) at the back of the cipher, logic blocks A and C may be generated by operation of their corresponding LFSRs in the forward direction and logic blocks B and D may be generated by operation of their corresponding LFSRs in the reverse direction (or vice versa). Alternatively, logic blocks A, B, C and D may all be generated by operation of their corresponding LFSRs in the same direction.
4. LFSR Seed Length: The LFSR seed length (k) is the length of the seed used to generate the logic block. The LFSR seed length (k) is a distinct integer greater than the block size B (e.g., B+1, B+2, B+3, B+4, etc.), which may be expressed as follows:

$$λ > B$$

5. LFSR Rate: The LFSR rate (ρ) is the number of “steps” that the LFSR progresses for each data block processed. The LFSR rate (ρ) is a predefined positive integer that is preferably equal to the block size B plus the number of skip bits n_{σ}, which may be expressed as follows:

$$ρ = B + {n}_{σ}$$

In this embodiment, the same LFSR rate (ρ) is used for all LFSRs. In other embodiments, the LFSR rate (ρ) may have different values based on the block size B. In other embodiments, the LFSR rate (ρ) may vary between different LFSRs and/or the LFSR rate (ρ) may vary within the same LFSR. Various implementations will be apparent to one skilled in the art.
6. Start Bit Position: The index position of the start bit (i) that determines the first bit of a λ-length sequence of bits of the LFSR object that will be used to populate the seed, which may be expressed as follows (assuming 0-based numbering):

$$0 \leq i \leq \vert LO\_n \vert - 1$$

7. Tap Bit Positions: The index positions of the tap bits that affect the calculation of the next output of the LFSR. The tap combination selected for each LFSR may be based on a primitive polynomial relative to the LFSR seed length (k) such that the maximum number of unique permutations may be generated. The number of permutations related to the taps should preferably exceed the desired maximum number of data blocks that need to be securely processed in an encryption/decryption session. The optimal tap combinations are preferably pre-selected for each allowable LFSR seed length (k).

It should be understood that one or more of the above parameters—e.g., the position of the logic block within the cipher, the LFSR direction, and/or the LFSR rate (ρ)—may be set in the overall configuration settings of the encryption/decryption scheme and excluded from the initialization vector configuration.

An example set of LFSR object parameters for a block size B of 128 bits and a logic block quantity (N) of 4 and a count of the skip bits (n_{σ}) of 1 is shown in Table 5 below:

TABLE 5

| | | | | LFSR | | Start | |
|---|---|---|---|---|---|---|---|
| | | | LFSR | Seed | LFSR | Bit | |
| Logic | LFSR | Posi- | Direc- | Length | Rate | Position | Tap Bit |
| Block | Object | tion | tion | λ | ρ | i | Positions |
| A | LO_0 | Front | Forward | 129 | 16 | 199 | 128, 123 |
| B | LO_2 | Front | Reverse | 130 | 16 | 42 | 129, 126 |
| C | LO_3 | Back | Forward | 131 | 16 | 252 | 130, 129, |
| | | | | | | | 83, 82 |
| D | LO_1 | Back | Reverse | 132 | 16 | 18 | 131, 102 |

Of course, it should be understood that the block size B and logic block quantity (N) will vary between different implementations. For example, as discussed above, it is possible to use a single logic block at the front of the cipher and a single logic block at the back of the cipher within the scope of the present invention.

### D. Cipher Key

Alternative to the setup object set and initialization vector described above, a single cipher key may be used to identify the LFSR seed length (through a look-up table, LUT), LFSR seed, mask, binary setup object 0 (SO_0), integer setup object 1 (SO_1), and binary setup object 2 (SO_2). Thus, the various objects of the encryption process may also be referred to as the cipher key, key, or portions thereof. In one example, the cipher key may be a sequence of 2048 bits that may be mapped to the various objects of the encryption process. Table 6 illustrates one example of a cipher key used in the encryption process.

TABLE 6

| | Quantity |
|---|---|
| Component | of Bits |
| LUT index for length of LFSR Seed A (λ_{A}) | 3 |
| LFSR Seed A | λ_{A} |
| LUT index for length of LFSR Seed B (λ_{B}) | 3 |
| LFSR Seed B | λ_{B} |
| LUT index for length of LFSR Seed C (λ_{C}) | 3 |
| LFSR Seed C | λ_{C} |
| LUT index for length of LFSR Seed D (λ_{D}) | 3 |
| LFSR Seed D | λ_{D} |
| Mask (SO_2) | 256 |
| Binary Setup Object 1 (SO_0) | 512 |
| Integer Setup Object 1 (SO_1) | 1024 |

As can be seen, each object used in the encryption process may be derived from the key as an alternative to the object sets and initialization vector, described above. While Table 6 illustrates one example of a key having a size of 2048 bits, it will be noted that the size of the key may vary based on the block size and the required bit size for each of the seeds and setup objects.

### E. Generation of Screen and Inverse Screen

The setup object set and initialization vector described above are used to generate a screen for a bit remapping operation and an inverse screen for an inverse bit remapping operation. Each screen provides a set of remapping instructions that identifies a correspondence between a plurality of original index positions and a plurality of destination index positions within an index block.

In this embodiment, a sub-screen generation process is used to generate an integer quantity (x) of unique sub-screens, each of size R, which are then combined to assemble a full screen of size B, as follows:

$$R = B / x : x ∈ ℤ : R \geq 16 bits$$

One skilled in the art will appreciate that the generation of sub-screens requires less hardware and increases performance compared to the generation of a full screen, but does not have a significant impact on the level of data security. Of course, in other embodiments, the process used to generate the sub-screens may be used to generate the full screen, in which case the sub-screen assembly process would not be required.

### 1. Generation of Sub-Screens

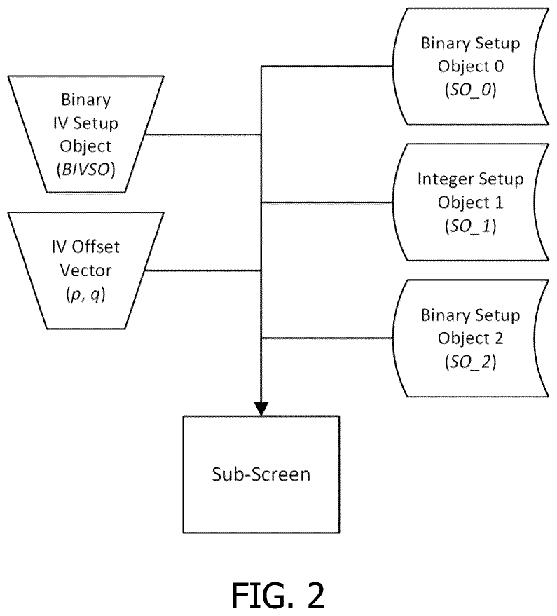

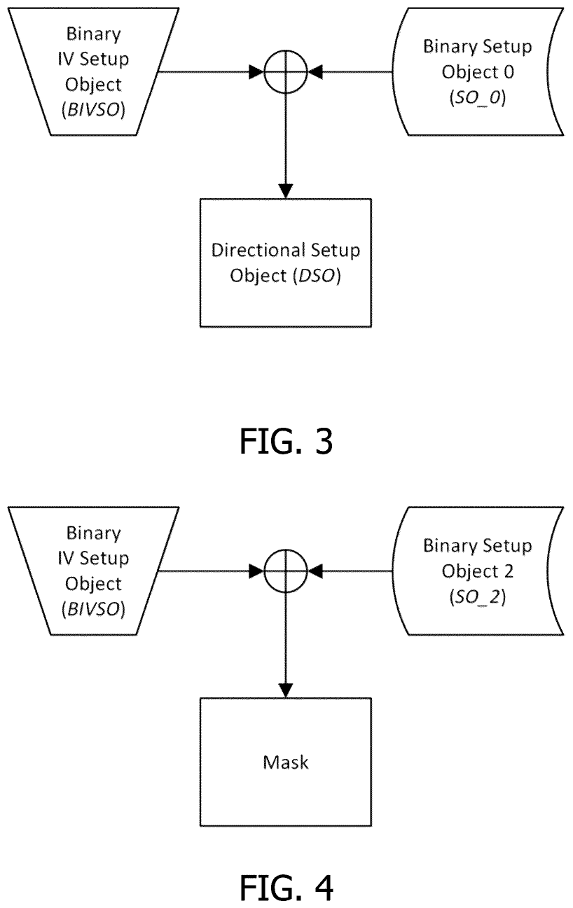

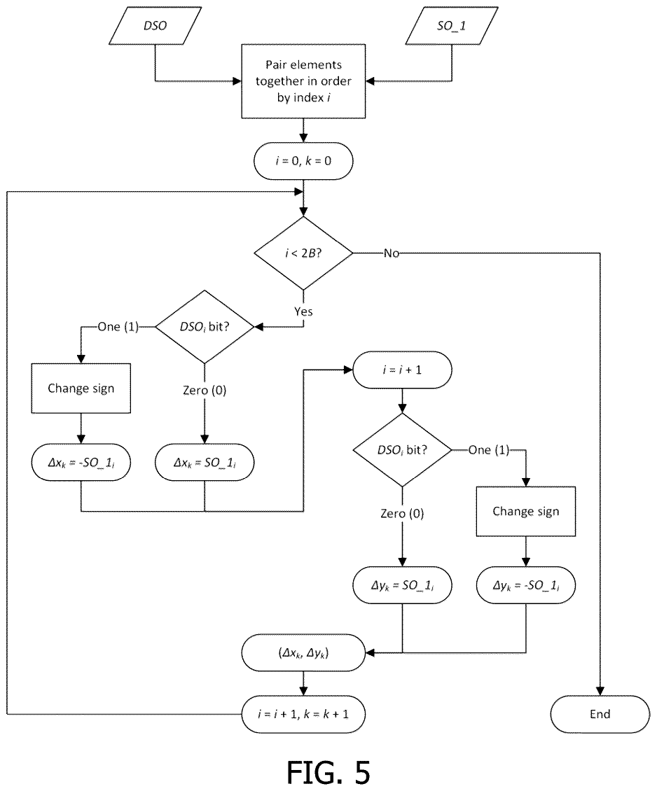

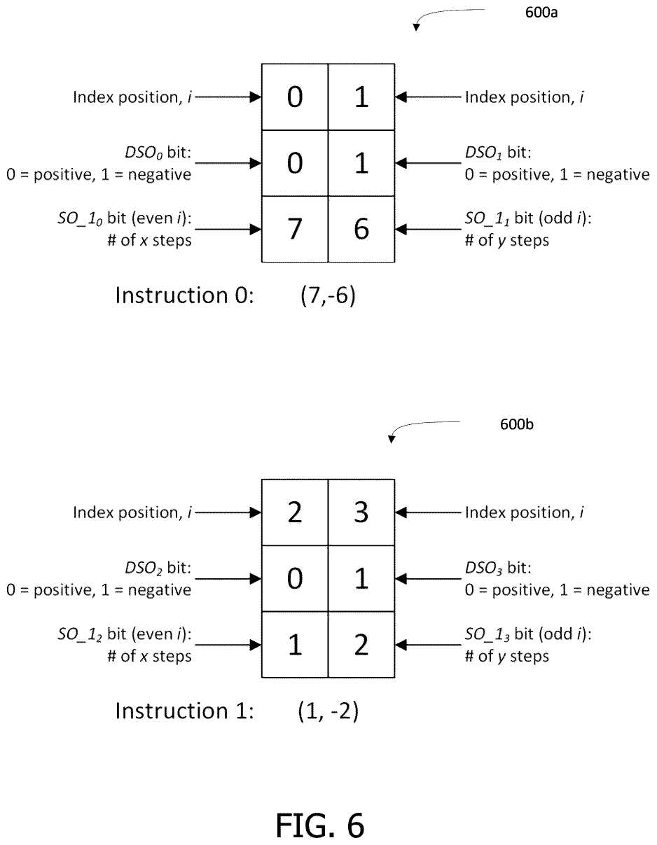

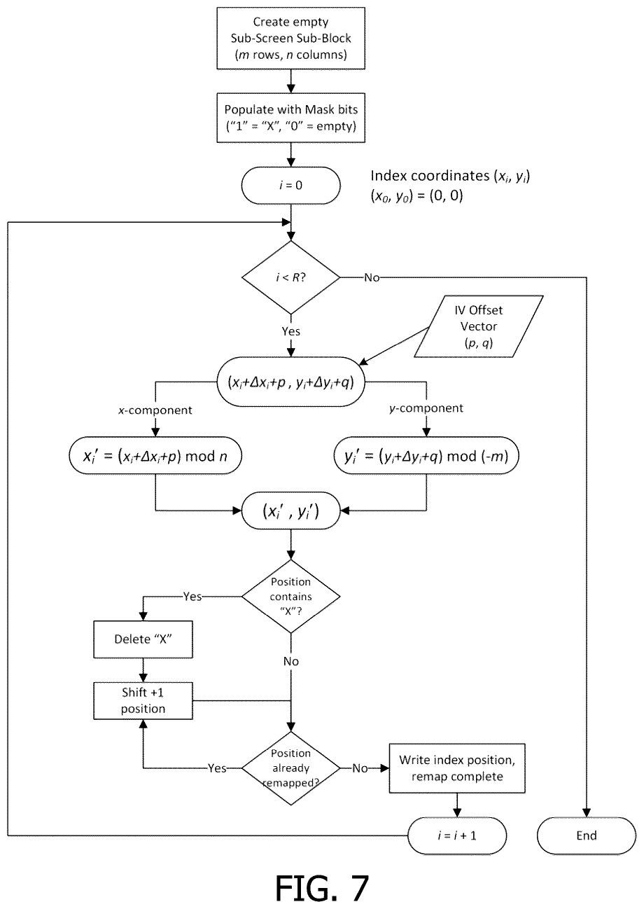

In this embodiment, the sub-screens are generated in accordance with the following steps: (1) obtain the objects and information needed to generate the sub-screens, as described below in connection with FIG. 2; (2) generate a directional setup object (DSO), as described below in connection with FIG. 3; (3) generate a mask, as described below in connection with FIG. 4; (4) generate movement instructions, as described below in connection with FIGS. 5 and 6; and (5) generate each sub-screen based on the movement instructions, the mask, and the offset vector, as described below in connection with FIGS. 7-9. Each of these steps will now be described in greater detail.

First, the objects and information needed to generate the sub-screens are obtained, as shown in FIG. 2. In this embodiment, the objects and information include the binary setup object 0 (SO_0), the integer setup object 1 (SO_1), the binary setup object 2 (SO_2), the binary IV setup object (BIVSO), and the IV offset vector (p,q).

Second, as shown in FIG. 3, a directional setup object (DSO) is created by implementing an XOR operation in which (1) the binary IV setup object (BIVSO) and the binary setup object 0 (SO_0) are the inputs to the XOR operation and (2) the directional setup object (DSO) is the output of the XOR operation. It can be appreciated that the XOR operation is applied on an index position-by-index position basis—e.g., the bit contained is the first index position of the binary IV setup object (BIVSO) is XOR-ed with the bit in the first index position of the binary setup object 0 (SO_0) to generate the bit in the first index position of the directional setup object (DSO), etc. Of course, in other embodiments, an XNOR operation may be used instead of the XOR operation.

Third, as shown in FIG. 4, the mask is created by implementing an XOR operation in which (1) the binary IV setup object (BIVSO) and the binary setup object 2 (SO_2) are the inputs to the XOR operation and (2) the mask is the output of the XOR operation. It can be appreciated that the XOR operation is applied on an index position-by-index position basis—e.g., the bit contained is the first index position of the binary IV setup object (BIVSO) is XOR-ed with the bit in the first index position of the binary setup object 2 (SO_2) to generate the bit in the first index position of the mask, etc. It can be appreciated that only B bits of the binary IV setup object (BIVSO) are used to generate the mask. In other embodiments, the binary setup object 2 (SO_2) is not used and B bits of the binary setup object 0 (SO_0) are used in its place to generate the mask. Of course, in other embodiments, an XNOR operation may be used instead of the XOR operation.

Fourth, the movement instructions are generated in accordance with the flow chart shown in FIG. 5. As can be seen, the bits of the directional setup object (DSO) and the integers of the integer setup object 1 (SO_1) are paired together by index position. Examples of four such pairings are shown in Table 7 below:

TABLE 7

| Index Position (i) | 0 | 1 | 2 | 3 |
|---|---|---|---|---|
| DSO | 0 | 1 | 0 | 1 |
| SO_1 | 7 | 6 | 1 | 2 |

As shown in the flow chart, two successive pairings are interpreted as a movement instruction—i.e., an xy-coordinate representing a shift in each direction for a particular index position, denoted as (Δx,Δy). The bit of the directional setup object (DSO) determines the sign of the corresponding integer of the integer setup object 1 (SO_1)—i.e., a bit of “0” is positive and a bit of “1” is negative.

Two exemplary movement instructions corresponding to the four pairings of Table 6 are shown in FIG. 6 as reference numbers 600a and 600b. As can be seen, the bit of DS0₀ (i.e., a “0” bit) and the integer of SO_1₀ (i.e., the integer “7”) are converted to a Δx of 7, and the bit of DS0₁ (i.e., a “1” bit) and the integer of SO_1₁ (i.e., the integer “6”) are converted to a Δy of −6. Thus, movement instruction 0 is (7, −6), indicating that the input index position should move right 7 positions and down 6 positions within the index block. Similarly, the bit of DS0₂ (i.e., a “0” bit) and the integer of SO_1₂ (i.e., the integer “1”) are converted to a Δx of 1, and the bit of DS0₃ (i.e., a “1” bit) and the integer of SO_1₃ (i.e., the integer “6”) are converted to a Δy of −2. Thus, movement instruction 1 is (1, −2), indicating that the input index position should move right 1 position and down 2 positions within the index block. This process continues until all the bits of the directional setup object (DSO) and all the integers of integer setup object 1 (SO_1) have been converted to movement instructions as described above. It should be understood that the movement instructions provide the initial remapping instructions for each of the index positions of the index block in terms of horizontal and vertical movement.

Fifth, the movements instructions, the mask, and the offset vector are used to generate the remapping relationships for each sub-screen in accordance with the flow chart shown in FIG. 7. Each sub-screen is given a number from 1 to B/R based on its order within the final full screen. Sub-screen 1 includes index positions 0 through (R−1) of the full screen, sub-screen 2 includes index positions R through (2R−1) of the full screen, sub-screen 3 includes index positions 2R through (3R−1) of the full screen, etc.

As shown in the flow chart, the process of creating the remapping relationships for each sub-screen begins by creating an empty sub-block of sub-block size R, with m rows and n columns, and pre-populating the index positions of the sub-block with the corresponding mask bits. A mask bit of “1” causes an “X” to be placed in the index position and a mask bit of “0” causes the index position to remain empty. Working in sequential order through each of the index positions, the process adds the coordinates of the input index position (xᵢ,yᵢ), the movement instruction (Δxᵢ,Δyᵢ), and the IV offset vector (p,q) to find the coordinates of the destination index position (xᵢ′,yᵢ′), as shown in the following equations:

$${x}_{i}^{′} = ( {x}_{i} + Δ {x}_{i} + p ) mod n$$

$${y}_{i}^{′} = ( {y}_{i} + Δ {y}_{i} + q ) mod ( - m )$$

All x- and y-components must fall within the sub-block, and values falling outside the sub-block are adjusted using modular arithmetic.

The process then checks the contents of the destination index position (xᵢ′,yᵢ′) and proceeds in accordance with the following rules:
1. If the destination index position is empty (i.e., does not contain an “X” or a remapped input index position), then the input index position is written into that index position. The remapping relationship between the input index position and destination index position is complete, and the process starts over with the next input index position.
2. If the destination index position contains an “X,” the “X” is deleted from that index position. The input index position is then shifted to the next larger index position, one position at a time, until it arrives at a destination index position that does not already contain a remapped input index position (i.e., a destination position that is either empty or contains an “X”). The input index position is then written into that index position. The remapping relationship between the input index position and destination index position is complete, and the process starts over with the next input index position.
3. If the destination index position contains a remapped input index position, the input index position is shifted to the next larger index position, one position at a time, until it arrives at a destination index position that does not already contain a remapped input index position (i.e., a destination position that is either empty or contains an “X”). The input index position is then written into that index position. The remapping relationship between the input index position and destination index position is complete, and the process starts over with the next input index position.

In the above rules, any shifting of an input index position to the next larger index position requires movement to the right and wrapping to the next row down in carriage-return fashion within the sub-block. It can be appreciated that the above process is repeated until every index position in the sub-screen contains a remapped input index position.

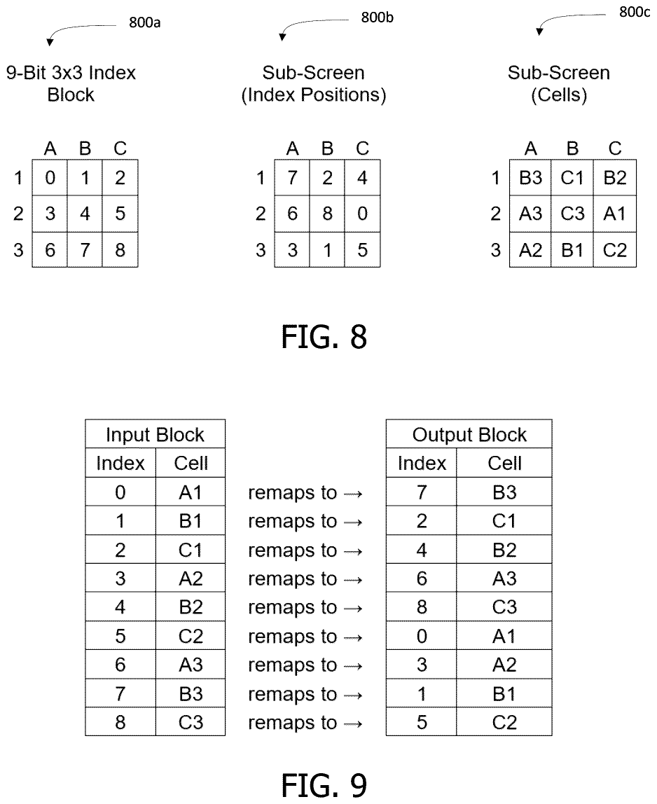

FIG. 8 depicts an index block 800a having 3 rows (rows 1-3) and 3 columns (columns A-C) along with sub-screens 800b and 800c that were generated using the process of FIG. 7. Sub-screen 800b shows the remapping relationships in an index position format (in which each input index position is shown in the cell of its destination index position) and sub-screen 800c shown the remapping relationships in a cell format (in which the column and row position of each input index position is shown in the cell of its destination index position). FIG. 9 depicts these same remapping relationships in a table format.

### 2. Screen Assembly

Once the sub-screens of sub-block size R have been generated, they are combined to create a full screen of block size B. For the case where R=B, the full screen is the same as the single sub-screen. The screen index positions, i_{B}, relate to the sub-screen index positions, i_{R}, using the following relationship (where the sub-screens are numbered from 1 to B/R, as described above):

$${i}_{B} = {i}_{R} + ( SubScreen Number - 1 ) \times R$$

It should be understood that the inverse screen is generated from the screen by reversing its remapping relationships.

While the above exemplary embodiment may be used to generate the sub-screen. In other embodiments, alternative methods of generating screen and/or sub-screens may be used to For example, a method of generating dynamic screens and inverse screens is described in further detail in commonly assigned U.S. Patent Application Publication No. US2025/0021671, which is incorporated herein by reference in its entirety.

### F. Generation of Logic Blocks

The LFSR object set and LFSR object parameters described above are used to generate a unique set of logic blocks for each of the data blocks to be processed during an encryption/decryption session. The number of logic blocks generated for each data block equals the number of LFSR objects in the LFSR object set (although additional LFSR objects may be provided that are not used to generate logic blocks, as described above). Each logic block is created using specific bits from a specific output step of its related LFSR—e.g., logic block A gets its bits from LFSR A, logic block B gets its bits from LFSR B, logic block C gets its bits from LFSR C, and logic block D gets its bits from LFSR D.

In this embodiment, each LFSR (e.g., any one of LFSRs A, B, C or D) is used to generate a unique logic block for each of the data blocks as follows:
1. An LFSR seed is populated from consecutive bits of the LFSR object, wherein the number of bits is equal to the specified LFSR seed length (k). The consecutive bits start at the specified start bit position (i) of the LFSR object. If there are insufficient bits remaining between the start bit position (i) and the end of the LFSR object, the process will wraparound to the beginning of the LFSR object.
2. A skip bit index (σ₀) is identified from the LFSR seeds and/or logic blocks.
3. The LFSR seed provides the initial state of the LFSR-step zero. For each subsequent LFSR step, the specified tap bits of the previous step are combined using an XOR operation (or alternatively an XNOR operation) to generate one new output bit that is placed into index position 0. The bits are then shifted one index position to generate the bits placed into the remaining index positions.
4. After a number of steps equal to the LFSR rate (ρ), the skip bit is extracted from the LFSR output by removing the bit in the position identified by the skip bit index (σ₀) to create a logic block.
5. After creating a first logic block a second logic block for each LFSR seed is generated by repeating the process of identifying new skip bit indices (α) and advancing the LFSR seed a number of steps equal to the LFSR rate (ρ). Using this process the LFSR seed advances to generate a logic block for each data block. FIG. 11, described further below, illustrates this process of advancing to generate the next logic block.

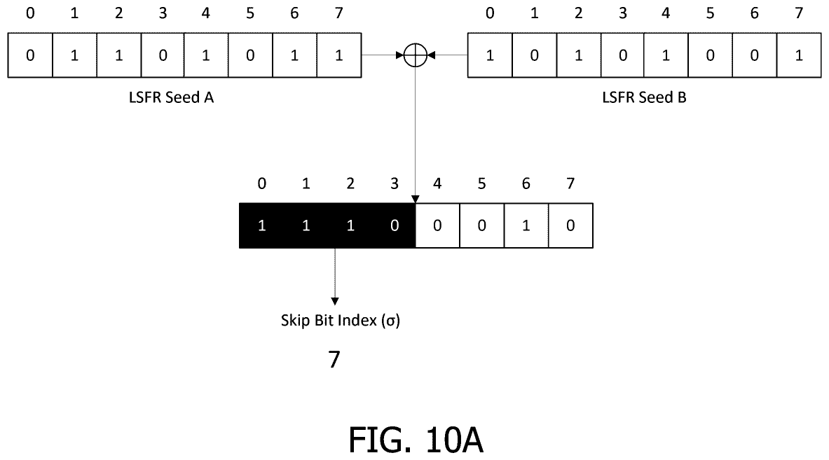

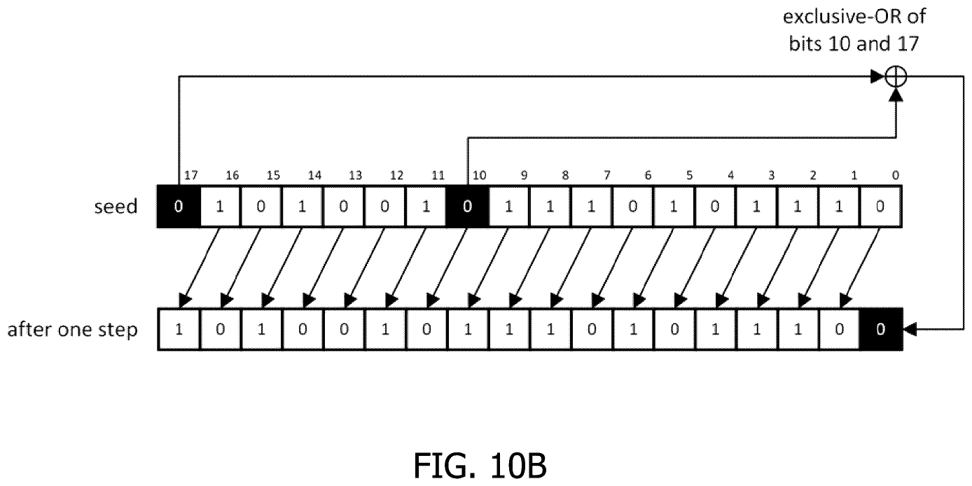

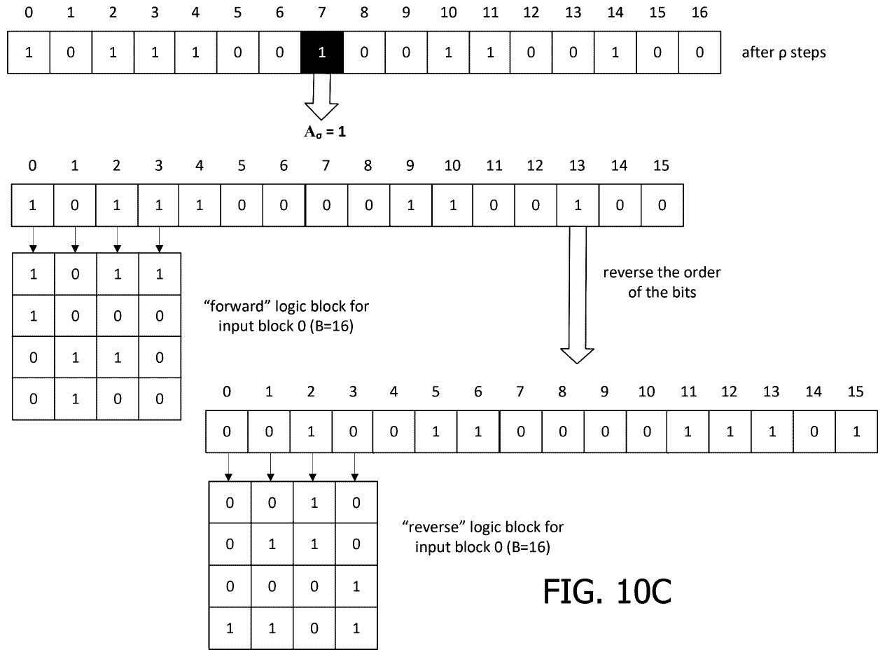

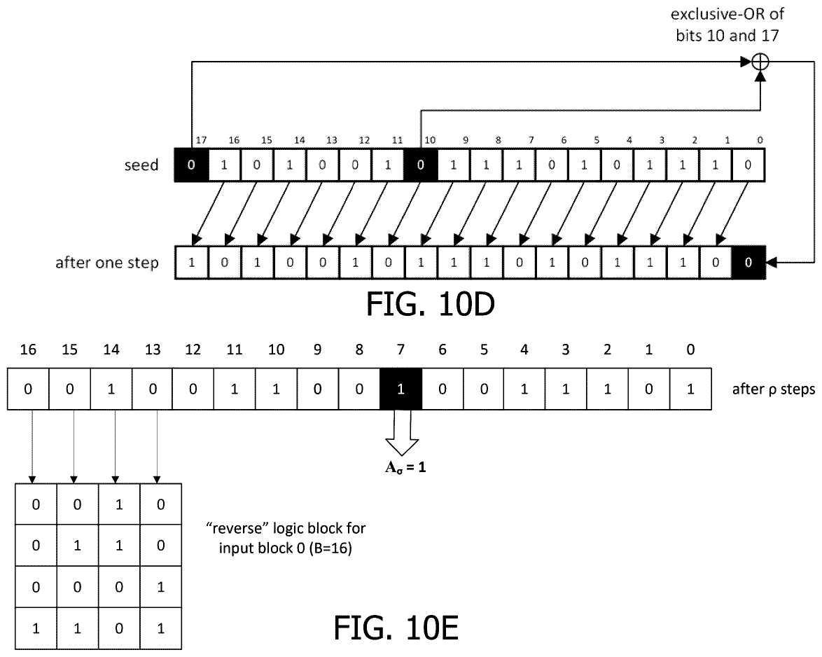

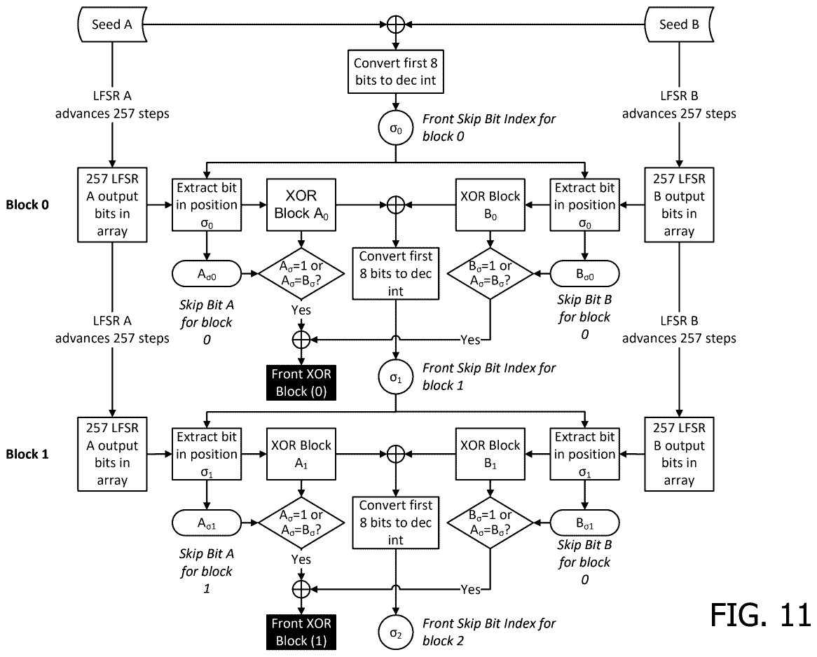

In order to illustrate the steps outlined above, example LFSRs are shown in FIGS. 10A-10D in which the block size (B) is 16, the LFSR seed length (λ) is 18, the tap bit positions are 10 and 17, and the LFSR rate (ρ) is 17.

FIG. 10A illustrates the process of identifying a skip bit index. In some embodiments, the LFSR seed bits are used to identify one or more skip bits to be extracted from the output. For example, as shown in FIG. 10A, the skip bits are identified by performing an XOR operation with the LFSR seed A and LFSR seed bit. Then, the first portion of the bits resulting from the operation may be converted to a decimal integer to identify the index for the skip bit. The number of bits used to identify is based on the block size (B). As a result, the number of bits is 4 for a block size (B) of 16 to allow for identifying a skip bit at any index of the LFSR seed. Other bit counts for each block size (B) will be apparent to one skilled in the art. A second skip bit may be determined by converting the next set of bits into an integer. This process repeats until a sufficient number of skip bits are identified to match the skip bit count (ne).

While the skip bit may be identified based on the LFSR seeds directly, it should be noted that alternative methods of identifying a skip bit could be used. For example, the skip bit index may be identified by converting any of the following to a decimal integer: the bits of a single LFSR seed, the bits from another XOR block generated for the current data block, or the bits from an XOR block applied to a previous data block. In one embodiment, the skip bit index may be identified by cycling the LFSR a number of times equal to the number of needed bits. For example, the LFSR A may be cycled 4 times—either before or after generation of the logic block described below—and the output used as the skip bit index. In another embodiment, during generation of two logic blocks for each seed, the skip bit index (a) may be determined by combining XOR Block A and XOR Block B from the first logic block through an XOR operation and converting the first number of bits from the result to an integer.

FIG. 10B illustrates an exemplary seed and first output. In this example, the seed bits are provided in reverse index position order, with the Least-Significant Bit (i=0) on the right end of the seed and the Most-Significant Bit (i=λ−1) on the left end of the seed. The bits in index positions 10 and 17 of the seed (i.e., the tap bits) are combined using an XOR operation to generate one new output bit that is placed in index position 0 of the first output. The bits in index positions 0 to 16 of the seed are shifted one index position, as shown, to create the bits in index positions 1 to 17 of the first output.

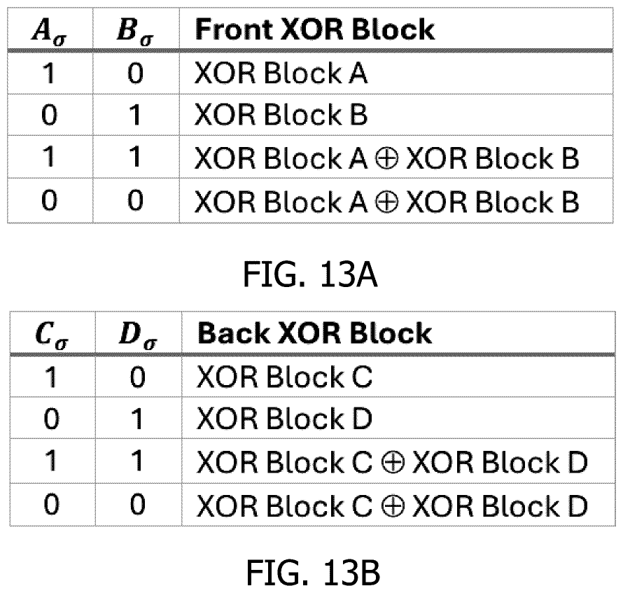

FIG. 10C illustrates the output after 17 (ρ) steps. To generate a logic block, the skip bit is extracted from the 17-bit output. To extract the skip bit, the bit at the index indicated by the skip bit index (a) is removed from the output and the subsequent bits are shifted to the preceding index. For a “forward” logic block, the resulting 16 bits form the bits of the logic block used to process the first data block (i.e., input block 0). For a “reverse” logic block, those 16 bits are mirrored or reversed to form the bits of the logic block used to process the first data block (i.e., input block 0). In some embodiments, the extracted skip bits—e.g. skip bit A (A_{σ}), skip bit B (B_{σ}), skip bit C (C_{σ}), skip bit D (D_{σ})—are retained to be later used as indicators to identify which logic blocks shall be applied to the front XOR block and the back XOR block, see FIGS. 13A and 13B further described below. The resulting output arrays with the skip bit removed then are identified as their respective XOR block (i.e XOR Block A, XOR Block B, XOR Block C, or XOR Block D).

It should be understood that the process shown in FIGS. 10A through 10C will continue until a logic block is created for each of the data blocks to be processed during an encryption/decryption session.

FIG. 10D illustrates another exemplary seed and first output. In this example, the seed bits are provided in reverse index position order, with the Most-Significant Bit (i=λ−1) on the left end of the seed and the Least-Significant Bit (i=0) on the right end of the seed. The bits in index positions 10 and 17 of the seed (i.e., the tap bits) are combined using an XOR operation to generate one new output bit that is placed in index position 0 of the first output. The bits in index positions 0 to 16 of the seed are shifted one index position, as shown, to create the bits in index positions 1 to 17 of the first output.

FIG. 10E illustrates the output after four (p) steps. To generate a “reverse” logic block, the 18-bit output is truncated to 16 bits, and those 16 bits form the bits of the logic block used to process the first data block (i.e., input block 0), as shown. It should be noted that this logic block is the same as the “reverse” logic block shown in FIG. 10B. Thus, it can be appreciated that a “reverse” logic block may be generated by either method—i.e., reversing the order of the output bits or reversing the order of the seed bits.

FIG. 11 illustrates using the logic block generation process to create two or more logic blocks for each LFSR seed according to an embodiment. As shown, the logic block generation process generates XOR Block A₀, XOR Block A₁, XOR Block B₀, and XOR Block B₁. In this embodiment, the variable XOR operation is applied to each pair (e.g. XOR Block A₀ with XOR Block B₀; and XOR Block A₁ with XOR Block B₁). Also shown in FIG. 11, the skip bit index (ai) for the front XOR block (1) is determined based off converting the first 8 bits of the result of performing an XOR operation on XOR Block A₀ with XOR Block B₀ to a decimal integer. In this way, the LFSR advances to generate logic blocks for each data block. Similarly, the back logic blocks may be generated by generating logic blocks for each data block and performing the variable XOR operation to determine which block to apply. In this way, the encryption scheme uses four LFSR objects to generate front logic blocks and back logic blocks based on a variable input of XOR blocks.

In an alternative embodiment, multiple logic blocks may be generated from each LFSR seed for each data block. For example, the logic block may generate XOR Block A₀, XOR Block A₁, XOR Block B₀, and XOR Block B₁ to be used as the front logic blocks for a single data block. Using the variable XOR operation a first front logic block is identified between XOR Block A₀ and XOR Block B₀. Similarly, a second front logic block is identified between XOR Block A₁ and XOR Block B₁. As a result the first and second front logic blocks may be both applied through AddXOR( ). Likewise, LFSR C and LFSR D may be used to generate two back logic blocks for each data block using the variable XOR operation.

### G. Encryption and Decryption of Data Blocks

For each data segment identified for encryption, the bits of the data segment are projected into the index positions of the index block to generate a data block. As discussed above, a single bit or multiple bits may be placed in each index position. A cipher is then used to encrypt the data blocks in accordance with an encryption scheme that applies the screen and logic blocks as described above—wherein the number and order of application of the screen and logic blocks will vary depending on the implementation.

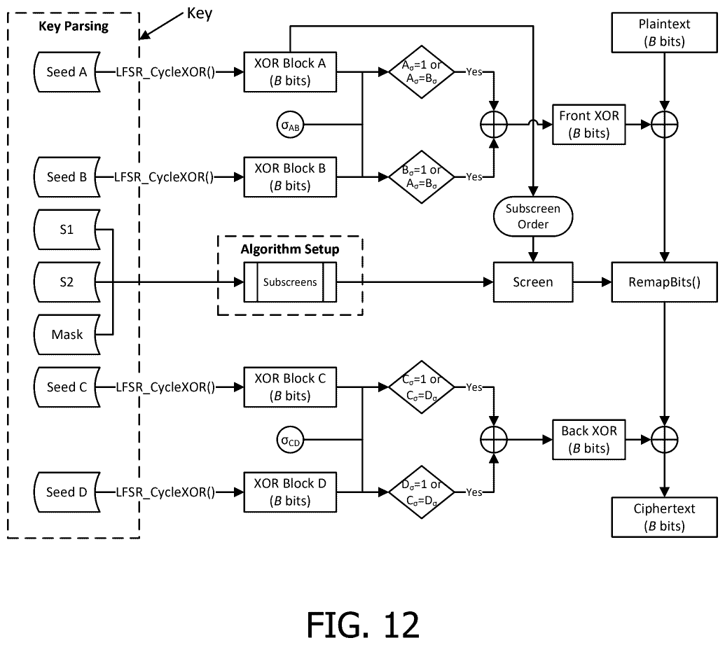

FIG. 12 depicts an exemplary encryption scheme of a cipher that utilizes the following operations: (1) an LFSR_CycleXOR( ) operation that uses an LFSR to generate the XOR block for each successive input data block; (2) a Variable XOR operation that identifies an XOR block to apply to the input data block or an intermediate state block (3) an AddXOR( ) operation (shown by the XOR symbol ⊕) that adds the identified XOR block to the input data block or an intermediate state data block using a bitwise XOR logical operation; and (4) a RemapBits( ) operation that applies the screen to an intermediate state data block using a bit remapping operation that may be performed bitwise or bytewise. While FIG. 12 illustrates applying both a front XOR block and a back XOR block, it will be noted that an encryption method may apply one of either the front XOR blocks or the back XOR blocks.

In this example, the encryption scheme uses one screen and four XOR blocks i.e., one or two XOR blocks (XOR Block A and/or XOR Block B) are positioned before the RemapBits( ) operation at the front of the cipher and one or two XOR blocks (XOR Block C and/or XOR Block D) are positioned after the RemapBits( ) operation at the back of the cipher. As described above, the LFSR object parameters in the initialization vector include an object position for each LFSR object, which determines the position of the XOR block within the cipher. Alternately, this position information may be set in the overall configuration of the encryption scheme and excluded from the initialization vector.

The encryption scheme occurs in one transformation round that includes the following steps: (1) the AddXOR( ) operation adds the front XOR block (XOR Block A and/or XOR Block B) to the input data block to generate a first intermediate state data block; (2) the RemapBits( ) operation applies the screen to the first intermediate state data block to generate a second intermediate state data block; and (3) the AddXOR( ) operation adds the back XOR block (XOR Block C and/or XOR Block D) to the second intermediate state block to generate the output data block. The front XOR blocks (XOR Block A and XOR Block B) may be added to the input data block in any order due to the commutative property of the XOR logical operation. Similarly, the back XOR blocks (XOR Block C and XOR Block D) may be added to the second intermediate state data block in any order due to the commutative property of the XOR logical operation.

In the exemplary embodiment, rather than deterministically applying both XOR Block A and XOR Block B as the front XOR blocks, the front XOR block may be determined by an indicator resulting from a variable XOR operation. To determine which XOR block to apply, a signal bit associated with each of XOR Block A and XOR Block B are evaluated. In some embodiments, the signal bits may be the skip bits extracted during logic block generation, described above. For example, the skip bit for block A (A_{σ}) and the skip bit for block B (B_{σ}) are compared to each other. If the skip bits have the same value, then both XOR Block A and XOR Block B are applied to the data block as the front XOR blocks. However, if the skip bits have a different value, the block having a bit value of 1 is applied as the front XOR block. FIG. 13A is a table showing the relationship between the skip bits and the XOR blocks applied as the front XOR block. In other embodiments, other operations may be used to combine XOR Block A and XOR Block B, such as XNOR, AND, NOR, or NAND.

While the exemplary embodiment shows generating an indicator using the variable XOR operation with extracted skip bits from the logic block generation as the signal bits, other signal bits may be used. For example, any of the following bits may be used as the signal bits to determine the front XOR block: the first bit of XOR Block A and the first bit of XOR Block B; the bit at an identified index of XOR Block A and XOR Block B; and the first bit of XOR Block A and XOR Block B for the preceding data block. It will be noted by using other methods of identifying the signal bit for the variable XOR operation, the variable XOR operation may be implemented without requiring the use of one or more skip bits.

The variable XOR operation may also be applied to determine the back XOR blocks. Determining the back logic blocks follows the same process described above but using XOR Block C and XOR Block D. FIG. 13B is a table showing the relationship between skip bits (C_{σ}) and (D_{σ}) and the XOR blocks applied as the back XOR block. As previously mentioned, the signal bits used to determine which block to apply may be the skip bits extracted during logic block generation. Alternatively, the first bits of XOR Block A and XOR Block B may be used as the signal bits to determine whether XOR Block C and/or XOR Block D are applied as the back logic block.

In other embodiments, the front XOR blocks (XOR Block A and XOR Block B) may both be applied sequentially rather than identifying or combining the front logic block through the variable XOR operation. In another embodiment, instead of applying the front XOR blocks (XOR Block A and XOR Block B) successively in series, XOR Block A and XOR Block B may be added to create a single equivalent XOR Block AB, which is then added to the input data block to generate a first intermediate state data block. Similarly, instead of applying the back XOR blocks (XOR Block C and XOR Block D) successively in series, XOR Block C and XOR Block D may be added to create a single equivalent XOR Block CD, which is then added to the second intermediate state block to generate the output data block.

In this embodiment, the maximum number of input data blocks (Φ) that can be securely sent through the encryption scheme in one encryption session is dependent on the LFSR seed length (λ) and the tap bit positions used to create each of the XOR blocks. In particular, the maximum number of input data blocks (Φ) will be achieved if (1) each LFSR seed length (λ) is distinct and (2) the tap bit positions for each LFSR are chosen to yield the maximum number of unique permutations before repeating itself—i.e., a maximal length LFSR that cycles through all possible 2^{λ}−1 states within the shift register except the state where all bits are zero (unless it contains all zeros, in which case it will never change). Also, the LFSR rate (ρ) may be chosen based on the desired secrecy level for a particular implementation. For example, in this implementation using skip bits, the LFSR rate is equal to the LFSR rate (ρ) is equal to the block size B plus the number of skip bits (n_{σ}). In another embodiment, the LFSR rate (ρ) is equal to the sub-block size R.

It should be understood that the maximum number of input data blocks (Φ) represents the maximum number of unique permutations of the bits of the LFSR objects that are used to create the XOR blocks. Of course, a larger number of input data blocks may be sent through the encryption scheme in one encryption session in implementations that do not require such a high level of data security. A smaller number of input data blocks may also be used.

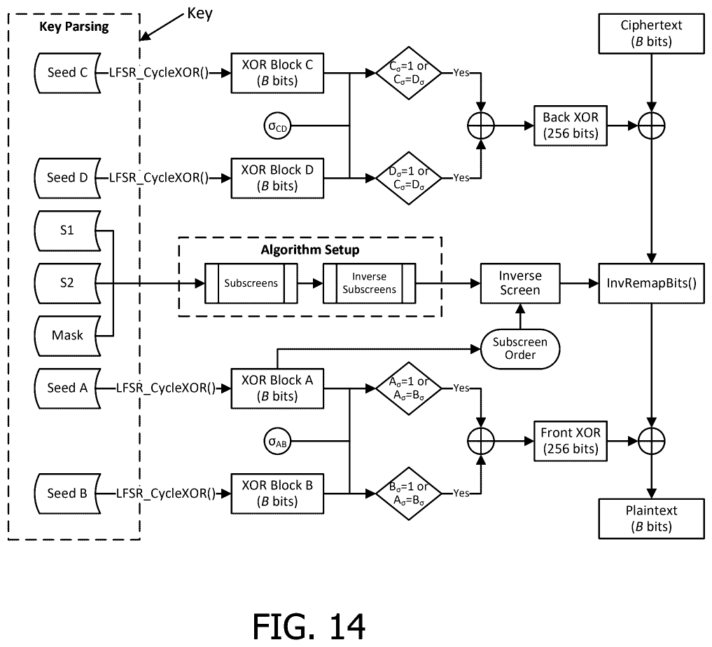

FIG. 14 depicts an exemplary decryption scheme of an inverse cipher that utilizes the following operations: (1) an LFSR_CycleXOR( ) operation that uses an LFSR to generate the XOR block for each successive input data block; (2) an AddXOR( ) operation (shown by the XOR symbol (D) that adds an XOR block to the input data block or an intermediate state data block using a bitwise XOR logical operation; and (3) an InvRemapBits( ) operation that applies the inverse screen to an intermediate state data block using a bit remapping operation that may be performed bitwise or bytewise.

In this example, the decryption scheme uses one inverse screen and the four XOR blocks used in the encryption scheme—i.e., two XOR blocks (XOR Block C and XOR Block D) are positioned before the InvRemapBits( ) operation and two XOR blocks (XOR Block A and XOR Block B) are positioned after the InvRemapBits( ) operation. Notably, the positions of the front and back XOR blocks are reversed compared to the positions of those same XOR blocks in the encryption scheme.

The decryption scheme occurs in one transformation round that includes the following steps: (1) the AddXOR( ) operation adds the Back XOR blocks (XOR Block C and/or XOR Block D based on identification by the signal bits) to the input data block to generate a first intermediate state data block; (2) the InvRemapBits( ) operation applies the inverse screen to the first intermediate state data block to generate a second intermediate state data block; and (3) the AddXOR( ) operation adds the Front XOR blocks (XOR Block A and/or XOR Block B based on the identification by the signal bits) to the second intermediate state block to generate the output data block. The Back XOR blocks (XOR Block C and XOR Block D) may be added to the input data block in any order due to the commutative property of the XOR logical operation. Similarly, the Front XOR blocks (XOR Block A and XOR Block B) may be added to the second intermediate state data block in any order due to the commutative property of the XOR logical operation.

In one embodiment, when implementing the variable XOR operation, the XOR blocks to be applied as the Back XOR blocks must be identified. To determine which block to apply, a signal bit associated with each of XOR Block C and XOR Block D are identified. When generation of the logic blocks includes a skip bit, the signal bit for each block may be the bit extracted during generation. As previously discussed, other suitable methods of identifying the signal bit may be used such as the first bit of the preceding logic blocks. Based on the signal bit, either XOR Block C, XOR Block D, or the result of performing an XOR operation with XOR Block C and XOR Block D are applied as the Back XOR block during decryption, see FIG. 13B. When determining the Front XOR blocks, the same operation is applied using XOR Block A and XOR Block B.

In other embodiments, instead of applying the back XOR blocks (XOR Block C and XOR Block D) successively in series, XOR Block C and XOR Block D may be added to create a single equivalent XOR Block CD, which is then added to the input data block to generate a first intermediate state data block. Similarly, instead of applying the front XOR blocks (XOR Block A and XOR Block B) successively in series, XOR Block A and XOR Block B may be added to create a single equivalent XOR Block AB, which is then added to the second intermediate state block to generate the output data block.

### H. Example

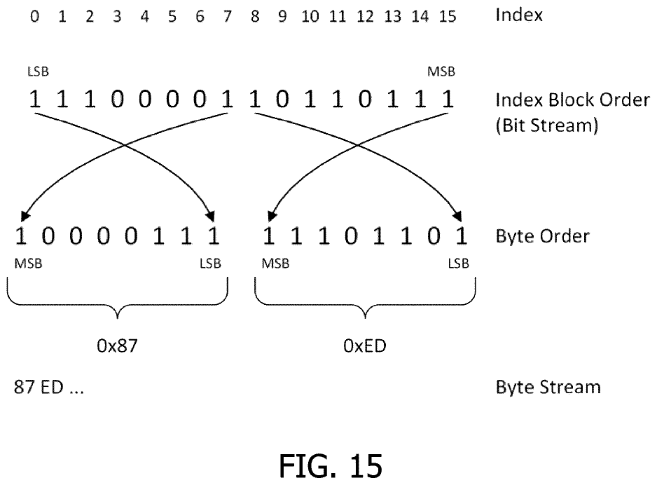

An example of this embodiment for logic block generation will be described with reference to FIGS. 15 to 23, some of which depict data as both a bit stream and a byte stream. As shown in FIG. 15, a bit stream is shown in index block order, with the Least-Significant Bit (i=0) on the left end of the stream and the Most-Significant Bit on the right end of the stream. To create a byte stream, the bits of the bit stream are grouped so that each group contains 8 bits, the bits are reversed within each 8-bit group, and each 8-bit group is converted to hexadecimal.

### Configuration Settings:

The configuration settings to be used in this example includes the block size, sub-block size, number of sub-blocks, and number of XOR blocks shown in Table 8 below:

TABLE 8

| Block | Sub-Block | # | # XOR | # Skip |
|---|---|---|---|---|
| Size | Size | Sub-Blocks | Blocks | Bits |
| (B) | (R) | (B/R) | (N) | (n_{σ}) |
| 256 bits | 16 bits | 16 | 4 | 1 |
| (16 × 16) | (4 × 4) | | | |

The configuration settings also include the LFSR object parameters shown in Table 9 below:

TABLE 9

| XOR | | LFSR |
|---|---|---|
| Block | Position | Direction |
| A | Front | Forward |
| B | Front | Reverse |
| C | Back | Forward |
| D | Back | Reverse |

### Setup Object Set, LFSR Object Set, and Initialization Vector:

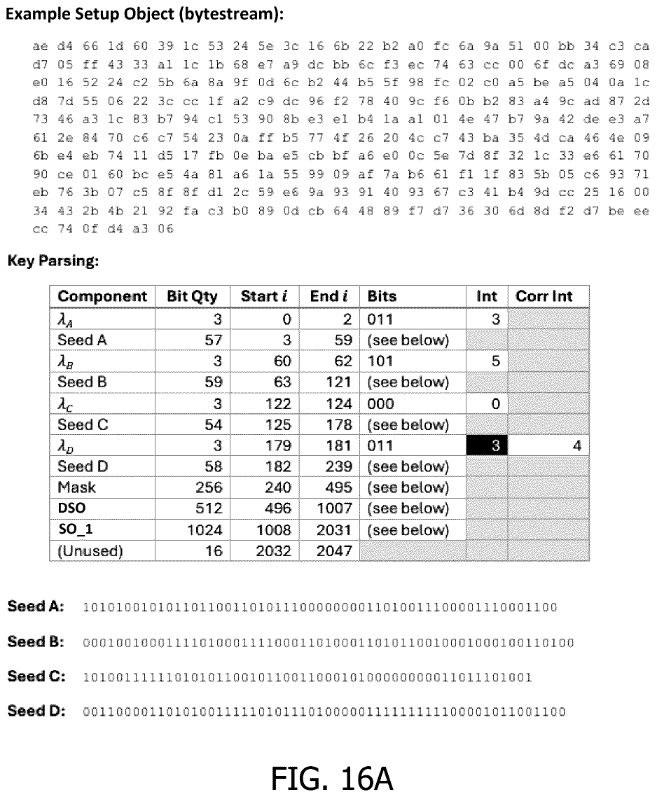

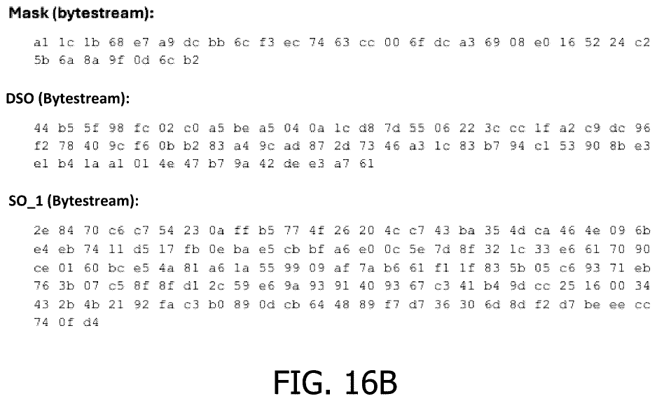

FIGS. 16A and 16B depict an example bytestream setup object. As shown, the key is parsed to identify the seed lengths (λ_{A}, λ_{B}, λ_{C}, and λ_{d}) and their respective seeds (Seed A, Seed B, Seed C, and Seed D). Through parsing the cipher key, the mask, DSO, and SO_1 are also identified for generation of the mask.

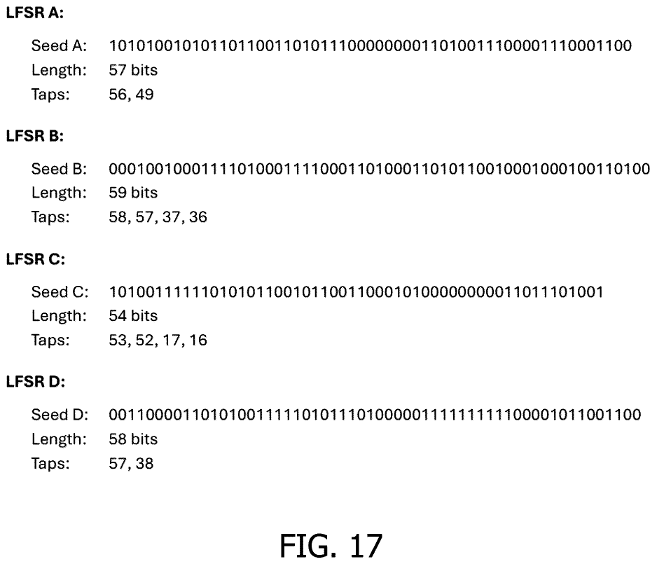

FIG. 17 depicts the seeds of LFSR A, LFSR B, LFSR C, and LFSR D, which is created from setup object of FIG. 16A. LFSR A has a seed length (λ_{A}) of 57 bits and tap bit positions 56 and 59. LFSR B has a seed length (λ_{B}) of 59 bits and tap bit positions 58, 57, 37, and 36. LFSR C has a seed length (λ_{C}) of 54 bits and tap bit positions 53, 52, 17, and 16. LFSR D has a seed length (λ_{D}) of 58 bits and tap bit positions 57 and 38.

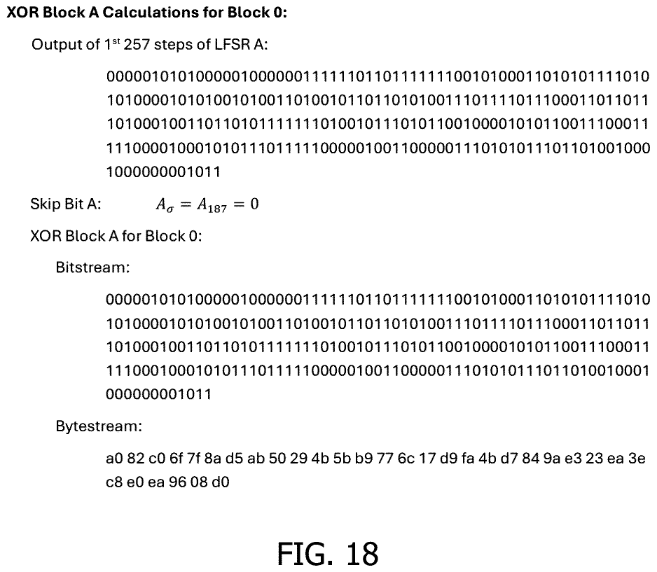

FIG. 18 depicts the output of advancing the LFSR seed A, shown in FIG. 17, 257 steps which is equal to the block size (B=256) plus the number of skip bits (n_{σ}=1). The skip bit index (σ) is 187, and the bit located at index 187 is removed from the LFSR output to create XOR Block A and to identify the skip bit (A_{σ}), shown here as 0.

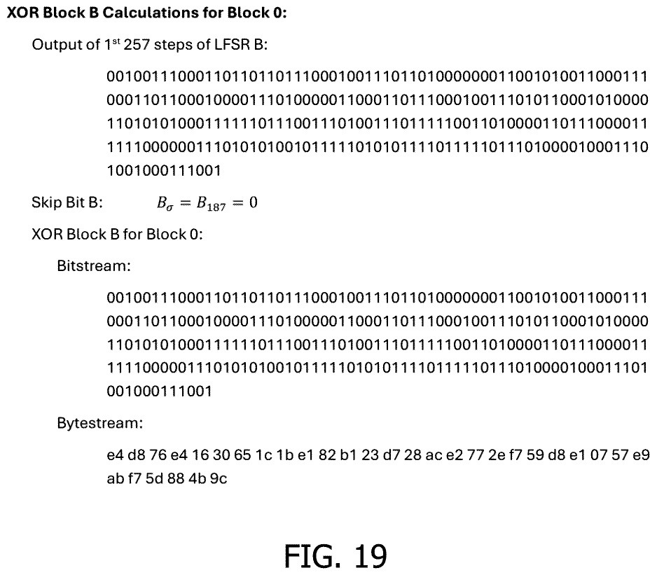

FIG. 19 depicts the output of advancing the LFSR seed B, shown in FIG. 17, 257 steps which is equal to the block size (B=256) plus the number of skip bits (n_{σ}=1). The skip bit index (σ) is 187, and the bit located at index 187 is removed from the LFSR output to create XOR Block B and to identify the skip bit (B_{σ}), shown here as 0.

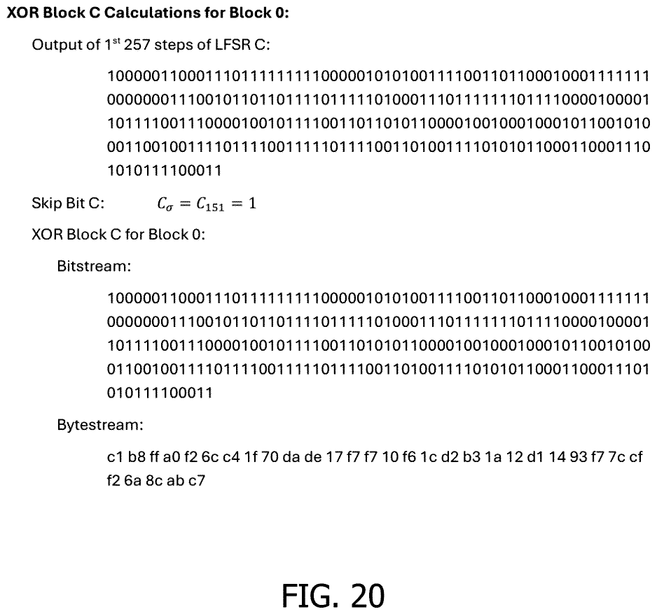

FIG. 20 depicts the output of advancing the LFSR seed C, shown in FIG. 17, 257 steps which is equal to the block size (B=256) plus the number of skip bits (n_{σ}=1). The skip bit index (σ) is 151, and the bit located at index 151 is removed from the LFSR output to create XOR Block C and to identify the skip bit (C), shown here as 1.

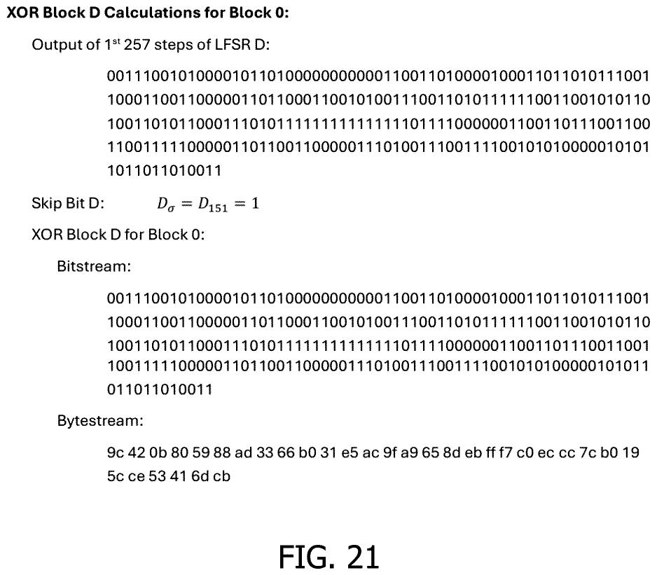

FIG. 21 depicts the output of advancing the LFSR seed D, shown in FIG. 17, 257 steps which is equal to the block size (B=256) plus the number of skip bits (n_{σ}=1). The skip bit index (σ) is 151, and the bit located at index 151 is removed from the LFSR output to create XOR Block D and to identify the skip bit (D_{σ}), shown here as 0.

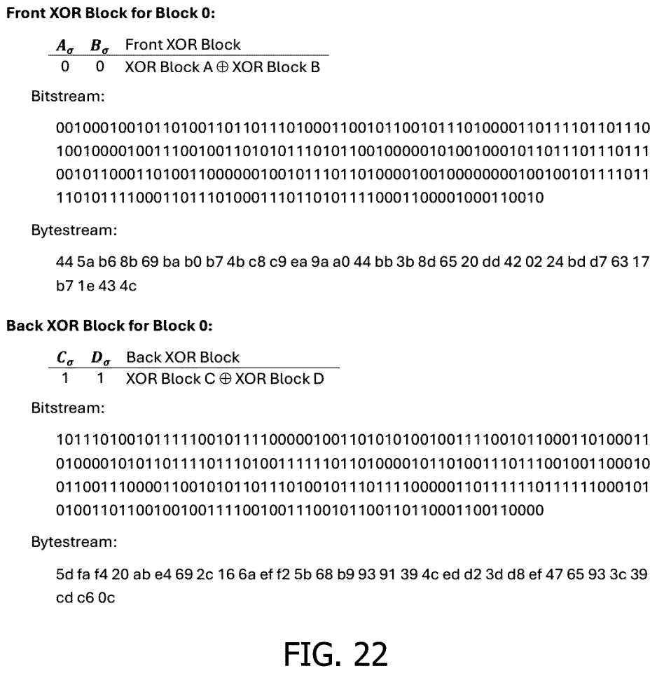

FIG. 22 depicts the bitstreams and bytestreams of the front XOR block and the back XOR block. The front XOR block is identified by evaluating the skip bits of LFSR A (A_{ν}=0) and LFSR B (B_{σ}=0). The skip bits of LFSR A and LFSR B are both 0; as a result, the front XOR block is equal to the result of an XOR operation as applied to XOR Block A and XOR Block B. The back XOR block is identified by evaluating the skip bits of LFSR C (C_{σ}=0) and LFSR D (D_{σ}=0). The skip bits of LFSR C and LFSR D are both 0; as a result, the back XOR block is equal to the result of an XOR operation as applied to XOR Block C and XOR Block D.

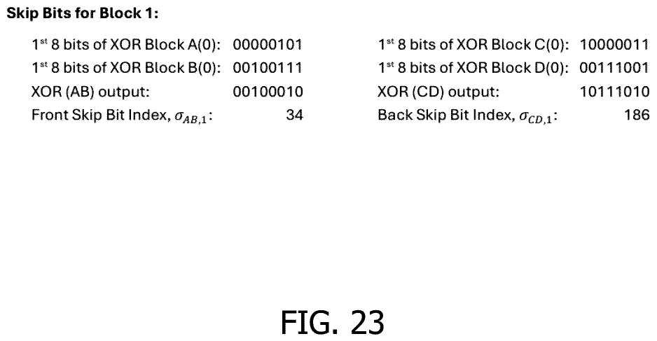

FIG. 23 depicts the process of identifying skip bits based on a pair of XOR Blocks. The first 8 bits of XOR Block A₀ and XOR Block B₀ are combined through an XOR operation and then the resulting output is converted to a decimal integer to determine the skip bit index σ_{AB,1} which will be used to extract the skip bit from the LFSR outputs for the next logic block. The same process is used with XOR Block C₀ and XOR Block D₀ to identify skip bit index σ_{CD,1}.

### II. COMPUTING DEVICES AND SYSTEMS

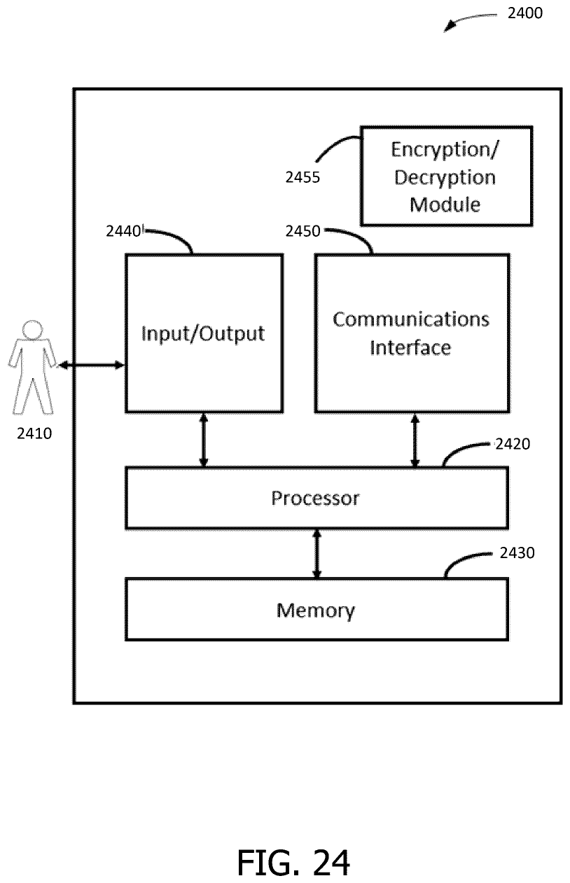

FIG. 24 illustrates an exemplary computing device 2400 that enables the encryption of data for storage or transport in accordance with the different embodiments of the present invention. Computing device 2400 may comprise any type of computing device capable of performing the functions described herein, including, but not limited to, desktop computing devices, laptop computing devices, computing peripheral devices, smart phones, wearable computing devices, medical computing devices, tablet computing devices, mobile computing devices, vehicular computing devices, and the like. While exemplary components of computing device 2400 will be described below, it should be understood that other components with characteristics that are more or less advanced or functional than those of the described components may alternatively be used in accordance with the present invention.

In the exemplary configuration shown in FIG. 24, computing device 2400 is operated by a user 2410 and generally includes the following components: a processor 2420, a memory area 2430, an input/output unit 2440, a communications interface 2450, and an encryption/decryption module 2455. Of course, other components may also be provided depending on the configuration of the computing device. Each of the components shown in FIG. 24 will be described below.

Processor 2420 is configured to execute instructions stored in memory area 2430 and functions to control input/output unit 2440 and communications interface 2450. The processor may comprise central processing units, microprocessors, microcontrollers, reduced instruction set circuits (RISC), application specific integrated circuits (ASIC), logic circuits (e.g., field-programmable gate array), and any other circuit or processor capable of executing the functions described herein. Processor 2420 may also include one or more processing units, for example, a multi-core configuration. Memory area 2430 may comprise any type of memory that allows data and executable instructions to be stored and retrieved, such as a flash memory drive, digital versatile disc (DVD), compact disc (CD), fixed (hard) drive, diskette, optical disk, magnetic tape, or semiconductor memory such as read-only memory (ROM). The encrypted data blocks generated in accordance with the present invention may be stored in memory area 2430 in any format, including structured formats (e.g., structured files or databases) or unstructured formats.

Preferably, data passing from processor 2420 to memory area 2430 is encrypted via the application of a screen and one or more logic blocks and, conversely, encrypted data passing from memory area 2430 to processor 2420 is decrypted via the application of an inverse screen and one or more logic blocks. The data may be encrypted and decrypted at the file system layer so that the screens and/or logic blocks are applied to all reads and writes to the file system. Alternatively, the encryption and decryption may operate below the file system layer using, for example, a volume manager.

Input/output unit 2440 is configured to receive information from and provide information to user 2410. In some examples, input/output unit 2440 may include an output adapter such as a video adapter and/or an audio adapter. Input/output unit 2440 may alternatively include an output device such as a display device, a liquid crystal display (LCD), an organic light emitting diode (OLED) display, an “electronic ink” display, and/or an audio output device such as a speaker or headphones. Input/output unit 2440 may also include any device, module, or structure for receiving input from user 2410, including, but not limited to, a keyboard, a pointing device, a mouse, a stylus, a touch sensitive panel, a touch pad, a touch screen, a gyroscope, an accelerometer, a position detector, or an audio input device. A single component such as a touch screen may function as both an output device and an input device. Input/output unit 2440 may further include multiple sub-components for carrying out the input and output functions. In other examples, input/output unit 2440 may be of limited functionality or non-functional as in the case of some wearable computing devices.

Communication interface 2450 is configured to enable communication with a remote device, such as a remote server, a remote computing device, or any other suitable system. Communication interface 2450 may include, for example, a wired or wireless network adapter or a wireless data transceiver for use with a mobile data network or Worldwide Interoperability for Microwave Access (WiMAX).

Encryption/decryption module 2455 is configured to enable the encryption, decryption, and data security functions described herein. Specifically, encryption/decryption module 2455 includes instructions that are executed by processor 2420 to generate the screens, inverse screens and logic blocks and then apply those screens, inverse screens and logic blocks to encrypt and decrypt a plurality of data blocks, as described generally above.

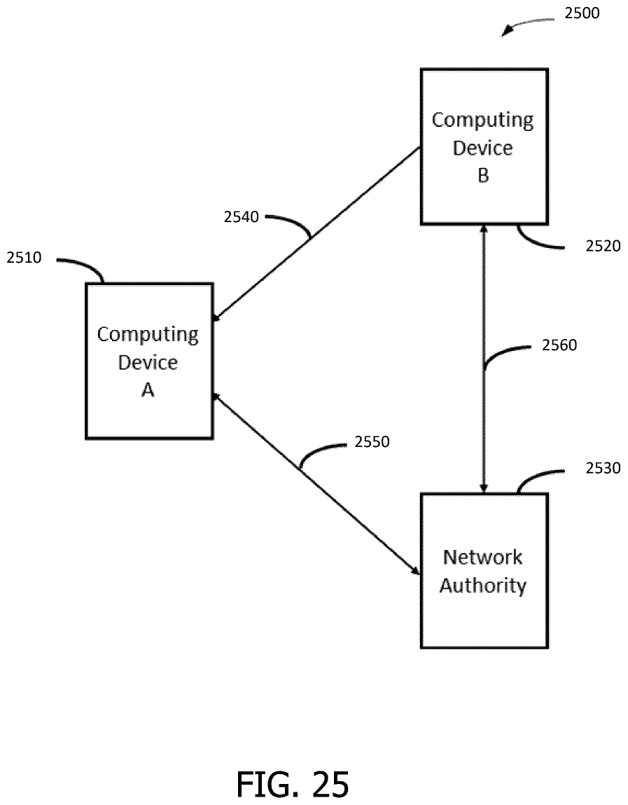

FIG. 25 is a block diagram of an exemplary system 2500 that enables the transport of encrypted data between a first computing device 2510 and a second computing device 2520 in accordance with the present invention. The configurations of first computing device 2510 and second computing device 2520 are the same as that of computing device 2400 shown in FIG. 24. In system 2500, a network authority 2530 is also provided to manage transport level encryption for data transmitted between first computing device 2510 and second computing device 2520.

As can be seen, first computing device 2510 is in communication with second computing device 2520 via a communication link 2540. Also, first computing device 2510 is in communication with network authority 2530 via a communication link 2550 and, similarly, second computing device 2520 is in communication with network authority 2530 via a communication link 2560. Communication links 2540, 2550 and 2560 represent any suitable wired or wireless communication links known in the art, including, but not limited to, those provided by the Internet or any other computer network.

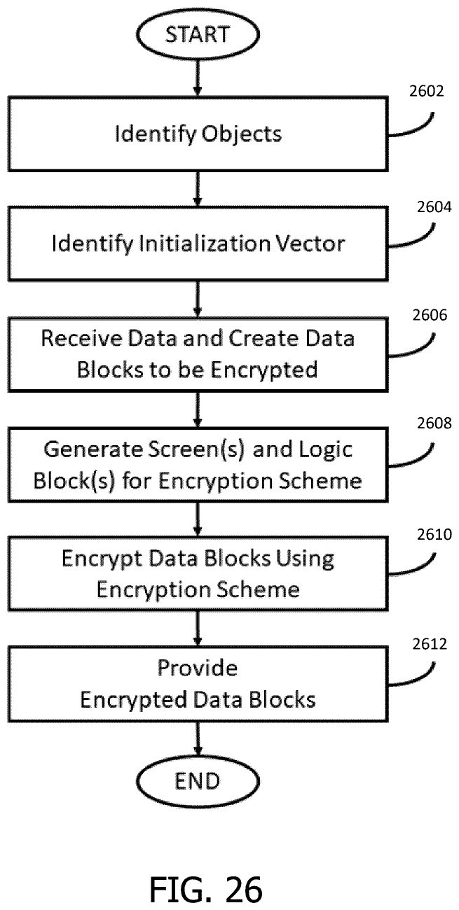

FIG. 26 is a flowchart of an exemplary data encryption method performed by computing device 2400 of FIG. 24 (or one of the computing devices of FIG. 25). In step 2602, computing device 2400 identifies the objects to be used in the encryption scheme. As described above, the objects may comprise a setup object set and an LFSR object set. In step 2604, computing device 2400 identifies an initialization vector to be used in the encryption scheme.

In step 2606, computing device 2400 receives data, identifies a plurality of data segments to be encrypted, and positions the bits of the data segments within index blocks to generate a plurality of data blocks. In step 2608, computing device 2400 generates one or more screen(s) and logic block(s) to be used in the encryption scheme. In step 2610, computing device 2400 encrypts each of the data blocks by applying the screen(s) and logic block(s) in accordance with the encryption scheme. Finally, in step 2612, computing device 2400 provides the encrypted data blocks for storage in memory area 2430. Alternatively, computing device 2400 may transport the encrypted data blocks to another computing device or to a remote server for storage.

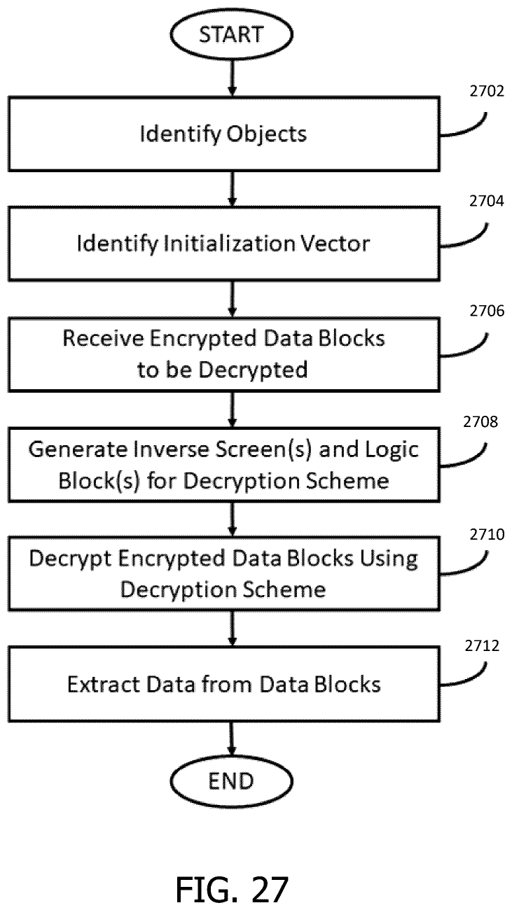

FIG. 27 is a flowchart of an exemplary data decryption method performed by computing device 2400 of FIG. 24 (or one of the computing devices of FIG. 25). In step 2702, computing device 2400 identifies the objects to be used in the decryption scheme. As described above, the objects may comprise a setup object set and an LFSR object set. In step 2704, computing device 2400 identifies an initialization vector to be used in the decryption scheme.

In step 2706, computing device 2400 receives previously encrypted data blocks to be decrypted. In step 2708, computing device 2400 generates one or more screen(s) and logic block(s) to be used in the decryption scheme. In step 2710, computing device 2400 decrypts each of the data blocks by applying the screen(s) and logic block(s) in accordance with the decryption scheme. Finally, in step 2712, computing device 2400 extracts the data from the decrypted data blocks in order to allow authorized users (e.g., users with the appropriate objects) to access the data.

One skilled in the art will appreciate that the data encryption and decryption methods described above in connections with FIGS. 26 and 27 may be implemented using any computer programming or engineering techniques including computer software, firmware, hardware or any combination or subset thereof. Any computer program, having computer-readable code means, may be embodied or provided within one or more computer-readable media, thereby making a computer program product, i.e., an article of manufacture. Computer-readable storage media are tangible and non-transitory and store information such as computer-readable instructions, data structures, program modules, and other data.

Computing devices that implement the encryption and decryption methods of the present invention provide several advantages that are not available from many existing encryption/decryption methodologies. For example, the encryption and decryption methods support error correcting code so as to increase reliability. Also, the encryption and decryption methods increase the efficiency and reduce the power consumption of the computing device, and may increase throughput—i.e., the amount of data moved from one place to another in a given time period. In addition, the encryption and decryption methods are flexible and may provide increased data security. Further, the encryption and decryption methods enable the use of smaller block sizes to support lower-latency applications. Finally, the encryption and decryption methods enable a larger volume of data to be secured by selecting a larger quantity of logic blocks and/or larger LFSR objects. Of course, other advantages will be apparent to one skilled in the art.

### III. GENERAL INFORMATION

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as”) provided with respect to certain embodiments is intended merely to better describe the invention and does not pose a limitation on the scope of the invention. No language in the description should be construed as indicating any non-claimed element essential to the practice of the invention.

The use of relative relational terms, such as first and second, top and bottom, and left and right, are used solely to distinguish one unit or action from another unit or action without necessarily requiring or implying any actual such relationship or order between such units or actions. For example, while the index blocks referenced herein require a certain spatial relationship between index positions of the index blocks, any equivalent structures may be used. Also, as described herein, the objects do not require any particular format, size, or definition other than to allow for the creation of the screens as described herein.

The use of the terms “comprises,” “comprising,” or any other variation thereof, are intended to cover a non-exclusive inclusion, such that a process, method, device, or system that comprises a list of elements does not include only those elements, but may include other elements not expressly listed or inherent to such process, method, device, or system.

While the present invention has been described and illustrated hereinabove with reference to several exemplary embodiments, it should be understood that various modifications could be made to these embodiments without departing from the scope of the invention. Therefore, the present invention is not to be limited to the specific configurations or methodologies of the exemplary embodiments, except insofar as such limitations are included in the following claims.

What is claimed and desired to be secured by Letters Patent is as follows:

1. A data encryption method using one or more linear-feedback shift registers (LFSRs), comprising:
identifying a first LFSR seed and a second LFSR seed wherein the first LFSR seed and the second LFSR seed each comprise a sequence of object bits;
identifying one or more front skip bit indices based on at least one of the first LFSR seed, the second LFSR seed, an output of cycling the first LFSR seed, an output of cycling the second LFSR seed, or one or more previous logic blocks;
generating a first logic block by (a) applying the first LFSR seed to a first LFSR as an initial state, (b) cycling the first LFSR at a predefined LFSR rate to generate a first LFSR output array, (c) extracting one or more bits at the one or more front skip bit indices, to generate a first logic block;
generating a second logic block by (a) applying the second LFSR seed to a second LFSR as an initial state, (b) cycling the second LFSR at the predefined LFSR rate to generate a second LFSR output array, (c) extracting one or more bits at the one or more front skip bit indices, to generate a second logic block; and
encrypting a data block in accordance with an encryption scheme that performs a bit modification operation using at least one of the first logic block or the second logic block.

2. The data encryption method of claim 1, wherein identifying the first LFSR seed comprises identifying a first start bit position and a first seed length associated with a first object, and wherein the first LFSR seed comprises a plurality of consecutive object bits in which (a) the plurality of consecutive object bits start at the first start bit position associated with the first object and (b) a number of the plurality of consecutive object bits equals the first seed length associated with the first object.

3. The data encryption method of claim 1, wherein identifying at least one front skip bit comprises converting at least a portion of at least one of the first LFSR seed or the second LFSR seed to an integer.

4. The data encryption method of claim 1, wherein identifying the one or more front skip bit indices comprises:
applying an XOR operation to the first LFSR seed and the second LFSR seed to generate a skip bit index seed; and
converting at least a portion of the skip bit index seed to a decimal integer.

5. The data encryption method of claim 1, wherein the bit modification operation comprises an XOR operation.

6. The data encryption method of claim 1, wherein the predefined LFSR rate is a function of a data block size.

7. The data encryption method of claim 6, wherein the predefined LFSR rate is equal to the data block size plus a count of the one or more front skip bit indices.

8. The data encryption method of claim 1, further comprising:
identifying a third LFSR seed and a fourth LFSR seed wherein the third LFSR seed and the fourth LFSR seed each comprise a sequence of object bits;
identifying one or more back skip bit indices based on at least one of the third LFSR seed, the fourth LFSR seed, an output of cycling the third LFSR seed, an output of cycling the fourth LFSR seed, or the one or more previous logic blocks;
generating a third logic block by (a) applying the third LFSR seed as an initial state of a third LFSR, (b) cycling the third LFSR at the predefined LFSR rate to generate a third LFSR output array, (c) extracting one or more bits at the one or more back skip bit indices, to generate a third logic block; and
generating a fourth logic block by (a) applying the fourth LFSR seed as an initial state of a fourth LFSR, (b) cycling the fourth LFSR at the predefined LFSR rate to generate a fourth LFSR output array, (c) extracting one or more bits at the one or more back skip bit indices, to generate a fourth logic block;
wherein the encryption scheme further performs a bit modification operation using at least one of the third logic block or the fourth logic block.

9. The data encryption method of claim 8, wherein the encryption scheme further comprises applying an encryption screen.

10. The data encryption method of claim 8, wherein identifying the one or more back skip bit indices comprises:
applying bit modification to the first logic block and the second logic block to generate a skip bit index seed; and
converting at least a portion of the skip bit index seed to a decimal integer.

11. A data encryption method, comprising:
receiving a plurality of data blocks each of which comprises a plurality of bits;
generating a first logic block, a second logic block, a third logic block, and a fourth logic block for each of the plurality of data blocks;
identifying a front logic block indicator and a back logic block indicator based on at least one of the first logic block, the second logic block, the third logic block, or the fourth logic block;
determining a front logic block wherein the front logic block comprises at least one of the first logic block, the second logic block, or a result of performing a first logical operation with the first logic block and the second logic block based on the front logic block indicator;
determining a back logic block wherein the back logic block comprises at least one of the third logic block, the fourth logic block, or a result of performing a second logical operation with the third logic block and the fourth logic block based on the back logic block indicator; and
encrypting the plurality of data blocks into a plurality of corresponding encrypted data blocks in accordance with an encryption scheme that transforms a data block into an encrypted data block by applying an encryption screen, the front logic block, and the back logic block, wherein the front logic block is applied before the encryption screen and the back logic block is applied after the encryption screen.

12. The data encryption method of claim 11, wherein the first logical operation and the second logical operation comprise at least one of an exclusive-OR operation (XOR) or an exclusive-NOR operation (XNOR).

13. The data encryption method of claim 11, wherein identifying the front logic block indicator comprises identifying a first signal bit of the first logic block, a second signal bit of the second logic block; and determining the front logic block indicator based on the first signal bit and the second signal bit.

14. The data encryption method of claim 13, further comprising extracting, before identifying the front logic block indicator and the back logic block indicator, the first signal bit from a first output used to generate the first logic block and the second signal bit from a second output used to generate the second logic block.

15. The data encryption method of claim 14, further comprising extracting, before identifying a front logic block indicator and a back logic block indicator, a third signal bit from the third logic block and a fourth signal bit form the fourth logic block.

16. The data encryption method of claim 11, wherein the first logic block, the second logic block, the third logic block, and the fourth logic block are generated using a first LFSR, a second LFSR, a third LFSR and a fourth LFSR, respectively.

17. A data encryption and decryption method using a plurality of linear-feedback shift registers (LFSRs), comprising:
creating a plurality of data blocks each of which comprises a plurality of bits;
generating a first logic block, a second logic block for each of the plurality of data blocks using a first LFSR and a second LFSR, respectively;
identifying a front skip bit index;
extracting a first skip bit from the first logic block based on the front skip bit index and a second skip bit from the second logic block based on the front skip bit index;
generating an encryption screen;
generating a decryption screen;
determining a front logic block wherein the front logic block comprises at least one of the first logic block, the second logic block, or a result of performing a first logical operation with the first logic block and the second logic block based on the first skip bit and the second skip bit;
encrypting the plurality of data blocks into a plurality of corresponding encrypted data blocks in accordance with an encryption scheme that transforms a data block into an encrypted data block by applying the encryption screen and the front logic block, wherein the front logic block is applied before the encryption screen; and
decrypting the plurality of encrypted data blocks into the corresponding data blocks in accordance with a decryption scheme that transforms the encrypted data block into the data block by applying the decryption screen and the front logic block, wherein the front logic block is applied after the decryption screen.

18. The data encryption and decryption method of claim 17, wherein identifying the front skip bit index comprises:
applying bit modification to a first LFSR seed associated with the first logic block and a second LFSR seed associated with the second logic block to generate a skip bit index seed; and
converting at least a portion of the skip bit index seed to a decimal integer.

19. The data encryption and decryption method of claim 17, wherein determining the front logic block comprises:
comparing the first skip bit to the second skip bit;
applying the result of performing a first logical operation with the first logic block and the second logic block in response to the first skip bit and the second skip bit having a same value;
applying the first logic block in response to the first skip bit and second skip bit having a different value and the first skip bit having a bit value of one; and
applying the second logic block in response to the first skip bit and second skip bit having a different value and the second skip bit having a bit value of one.

20. The data encryption and decryption method of claim 17, wherein the first logical operation comprises at least one of an exclusive-OR operation (XOR) or an exclusive-NOR operation (XNOR).

21. The data encryption and decryption method of claim 17, further comprising:
generating a third logic block, and a fourth logic block for each of the plurality of data blocks using a third LFSR and a fourth LFSR, respectively;
identifying a back skip bit index;
extracting a third skip bit from the third logic block based on the back skip bit index and a fourth skip bit from the fourth logic block based on the back skip bit index; and
determining a back logic block wherein the back logic block comprises at least one of the third logic block, the fourth logic block, or a result of performing a second logical operation with the third logic block and the fourth logic block based on the third skip bit and the fourth skip bit;
wherein, during the encrypting step, the back logic block is applied after the encryption screen and wherein, during the decrypting step, the back logic block is applied before the decryption screen.

22. The data encryption and decryption method of claim 21, wherein identifying the back skip bit index comprises:
applying bit modification to the first logic block and the second logic block to generate a skip bit index seed; and
converting at least a portion of the skip bit index seed to a decimal integer.
